(19) United States
(12) Patent Application Publication
(10) Pub. No.: US 2026/0221109 A1
(43) Pub. Date: Jul. 30, 2026

(54) DISPLAY DEVICE AND ELECTRONIC DEVICE

(71) Applicant: Samsung Display Co., Ltd., Yongin-si (KR)

(72) Inventors: Jin Seon KWAK, Yongin-si (KR); Jang Mi KANG, Yongin-si (KR); Kyung Bae KIM, Yongin-si (KR); Keon Min OH, Yongin-si (KR); Yun Jang PYUN, Yongin-si (KR)

(73) Assignee: Samsung Display Co., Ltd., Yongin-si (KR)

(21) Appl. No.: 19/436,666

(22) Filed: Dec. 30, 2025

(30) Foreign Application Priority Data
Jan. 16, 2025 (KR) 10-2025-0006640

(51) Int. Cl. G09G 3/3291; G09G 3/32; G09G 3/3266

(52) U.S. Cl. CPC G09G 3/3291; G09G 3/32; G09G 3/3266; G09G 2310/0267; G09G 2310/0275; G09G 2320/0204; G09G 2330/04

(57) ABSTRACT

A display device in which a noise of a driving voltage and a voltage drop may be reduced, and an electronic device are provided. The display device includes: a display panel including a display area and a non-display area; a data driver, which is in the non-display area and is adjacent to a first edge of the display area; and a first decoupling circuit, which is in the non-display area, is adjacent to a second edge of the display area, and is connected to a sub-pixel of the display area through a driving voltage line, the second edge being opposite to the first edge.

### CROSS-REFERENCE TO RELATED APPLICATION

This application is based on and claims priority from Korean Patent Application No. 10-2025-0006640 filed on January 16, 2025 in the Korean Intellectual Property Office, the disclosure of which is incorporated herein by reference in its entirety.

### BACKGROUND

### Field

The present disclosure relates to a display device, and more particularly, to a display device in which a noise of a driving voltage and a voltage drop may be reduced, and an electronic device.

### Description

An organic light-emitting diode display, unlike a liquid-crystal display, is self-luminous. Accordingly, an organic light-emitting diode display does not require a separate light source and thus the organic light-emitting diode display may be made lighter and thinner. In addition, the organic light-emitting diode display has high-quality characteristics such as low power consumption, high luminance and fast response speed.

### SUMMARY

Aspects of one or more example embodiments of the present disclosure provide a display device in which a noise of a driving voltage and a voltage drop may be reduced, and an electronic device including the display device.

According to an aspect of an example embodiment of the present disclosure, there is provided a display device including: a display panel including a display area and a non-display area; a data driver, which is in the non-display area and is adjacent to a first edge of the display area; and a first decoupling circuit, which is in the non-display area, is adjacent to a second edge of the display area, and is connected to a sub-pixel of the display area through a driving voltage line, the second edge being opposite to the first edge.

According to an aspect of an example embodiment of the present disclosure, there is provided an electronic device including a display device configured to display a display screen. The display device includes: a display panel including a display area and a non-display area; a data driver, which is in the non-display area and is adjacent to a first edge of the display area; and a first decoupling circuit, which is in the non-display area, is adjacent to a second edge of the display area, and is connected to a sub-pixel of the display area through a driving voltage line, the second edge being opposite to the first edge.

### BRIEF DESCRIPTION OF DRAWINGS

The above and other aspects and features of the present disclosure will become more apparent by describing in detail example embodiments thereof with reference to the attached drawings, in which:

FIG. 1 is an exploded, perspective view of a display device according to an embodiment of the present disclosure;

FIG. 2 is a block diagram showing a display device according to an embodiment of the present disclosure;

FIG. 3 is an equivalent circuit diagram of a first sub-pixel according to an embodiment of the present disclosure;

FIG. 4 is a view showing an example of a layout of a display panel according to an embodiment of the present disclosure;

FIGS. 5 and 6 are views showing examples of a layout of a display area of FIG. 4;

FIG. 7 is a cross-sectional view showing an example of the display panel taken along line I1 – I1’ of FIG. 5;

FIG. 8 is a cross-sectional view showing area A1 of FIG. 7 in detail;

FIG. 9 is a diagram for explaining a decoupling capacitor located in a decoupling circuit;

FIG. 10 is a cross-sectional view showing area A2 of FIG. 4 in detail;

FIG. 11 is a cross-sectional view showing an example of the display panel taken along line I2 – I2’ of FIG. 10;

FIG. 12 is a block diagram of an electronic device according to an embodiment of the present disclosure; and

FIGS. 13, 14 and 15 are views showing electronic devices according to a variety of embodiments of the present disclosure.

### DETAILED DESCRIPTION

The present disclosure will now be described more fully hereinafter with reference to the accompanying drawings, in which example embodiments of the disclosure are shown. The disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

It will also be understood that when a layer is referred to as being "on" another layer or substrate, it may be directly on the other layer or substrate, or intervening layers may also be present. The same reference numbers indicate the same components throughout the specification. In the attached figures, a thickness of layers and regions is exaggerated for clarity.

Although the terms "first", "second", etc. may be used herein to describe various elements, these elements, should not be limited by these terms. These terms may be used to distinguish one element from another element. Thus, a first element discussed below may be termed a second element without departing from teachings of one or more embodiments. The description of an element as a "first" element may not require or imply the presence of a second element or other elements. The terms "first", "second", etc. may also be used herein to differentiate different categories or sets of elements. For conciseness, the terms "first", "second", etc. may represent "first-category (or first-set)", "second-category (or second-set)", etc., respectively.

Features of various embodiments of the present disclosure may be combined partially or totally. As will be clearly appreciated by those skilled in the art, technically various interactions and operations are possible. Various embodiments may be practiced individually or in combination.

Hereinafter, example embodiments will be described with reference to the accompanying drawings.

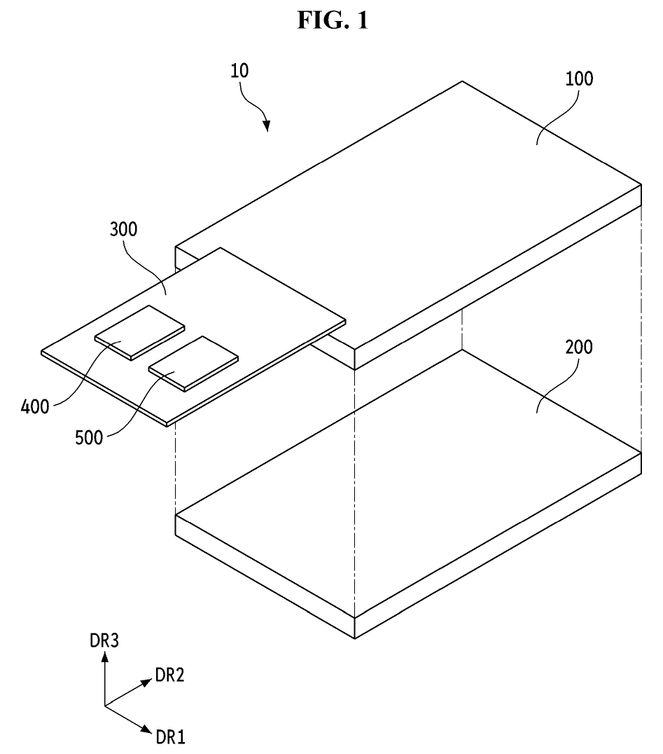

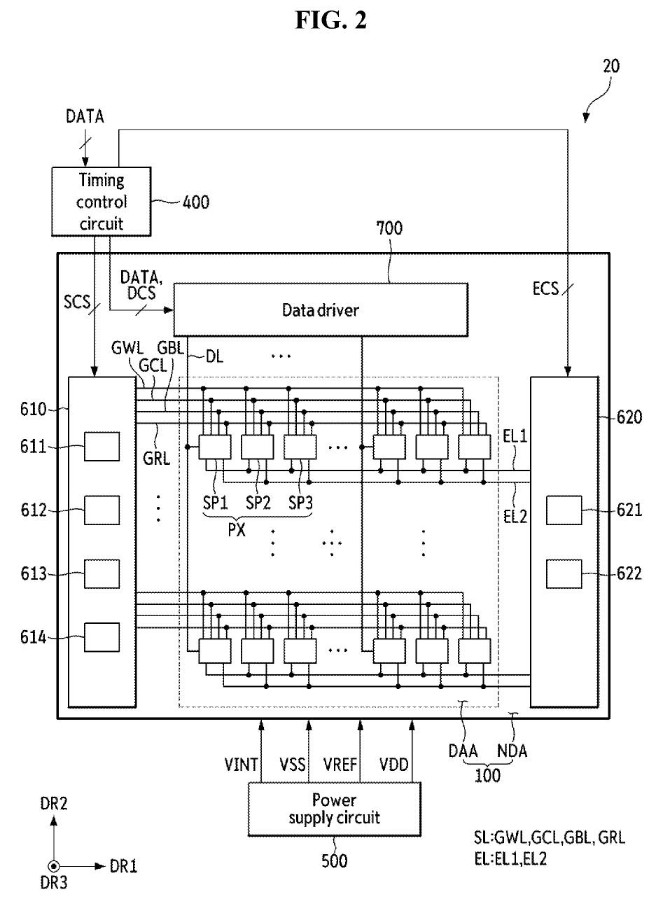

FIG. 1 is an exploded, perspective view of a display device according to an embodiment of the present disclosure. FIG. 2 is a block diagram showing a display device according to an embodiment of the present disclosure.

Referring to FIGS. 1 and 2, a display device 10 according to an embodiment may display a moving image or a still image. The display device 10 according to an embodiment may be employed by a portable electronic device such as a mobile phone, a smart phone, a tablet PC, a mobile communications terminal, an electronic notebook, an electronic book, a portable multimedia player (PMP), a navigation device and an ultra mobile PC (UMPC). For example, the display device 10 according to an embodiment of the present disclosure may be used as a display unit of a television, a laptop computer, a monitor, an electronic billboard, or the Internet of Things (IOT). Alternatively, the display device 10 according to an embodiment of the present disclosure may be applied to a smart watch, a watch phone, or a head-mounted display (HMD) for implementing virtual reality and augmented reality. However, the embodiments of the present disclosure are not limited thereto.

According to an embodiment, the display device 10 may include a display panel 100, a heat dissipation layer 200, a circuit board 300, a timing control circuit 400, and a power supply circuit 500.

The display panel 100 may have a shape similar to a rectangular shape when viewed from the top. For example, the display panel 100 may have a shape similar to a rectangle having shorter sides in a first direction DR1 and longer sides in a second direction DR2 intersecting the first direction DR1 when viewed from the top. In the display panel 100, corners where the shorter sides in the first direction DR1 meet the longer sides in the second direction DR2 may be rounded with a predetermined curvature or may have a right angle. The shape of the display panel 100 when viewed from the top is not limited to a rectangular shape, but may be formed in a different shape such as, for example, a shape similar to other polygonal shapes, a circular shape, or an elliptical shape. The shape of the display device 10 may conform to a shape of the display panel 100 when viewed from the top, but the embodiments of the present disclosure are not limited thereto.

The display panel 100 may include a plurality of pixels PX, a plurality of scan lines SL, a plurality of emission control lines EL, a plurality of data lines DL, a scan driver 610, an emission driver 620, and a data driver 700. The display panel 100 may be divided into a display area DAA where images are displayed, and a non-display area NDA where no image is displayed as shown in FIG. 2.

The plurality of pixels PX may be located in the display area DAA. The pixels PX may be arranged in a matrix in the first direction DR1 and the second direction DR2. The scan lines SL and the emission control lines EL may extend in the first direction DR1 and may be arranged in the second direction DR2. The data lines DL may extend in the second direction DR2 and may be arranged in the first direction DR1.

The plurality of scan lines SL may include a plurality of write scan lines GWL, a plurality of control scan lines GCL, a plurality of bias scan lines GBL, and a plurality of reference scan lines GRL. The plurality of emission control lines EL may include a plurality of first emission control lines EL1 and a plurality of second emission control lines EL2.

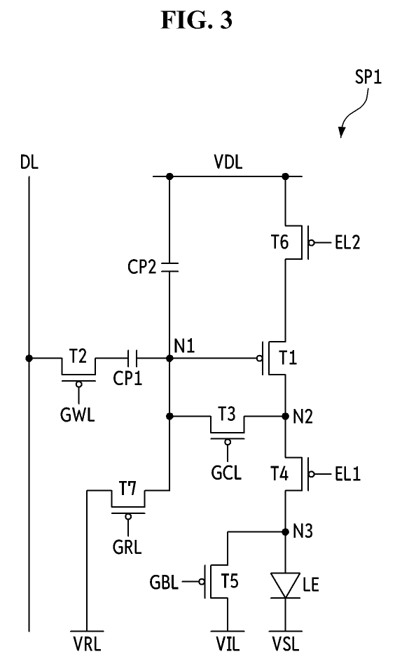

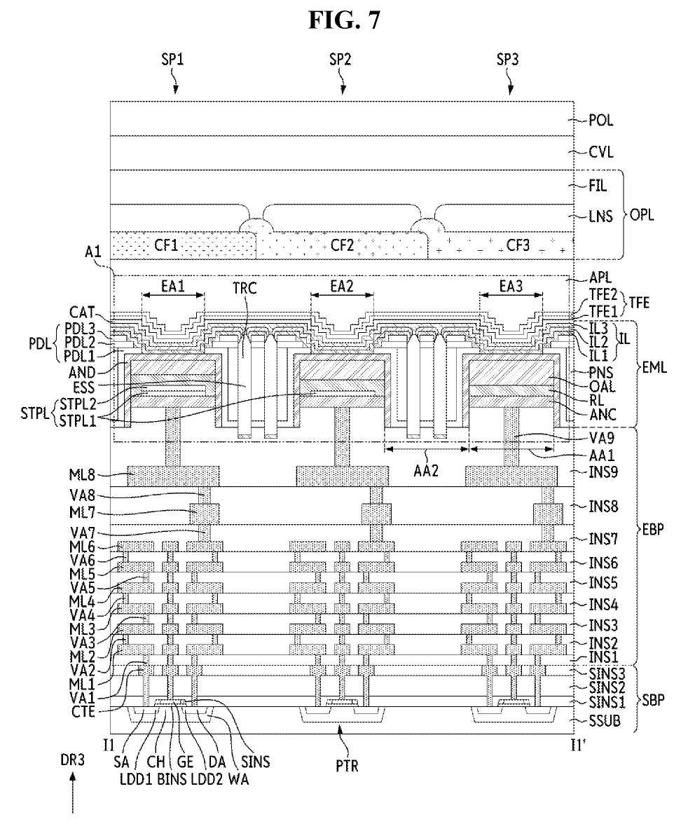

The plurality of pixels PX may include a plurality of sub-pixels SP1, SP2, and SP3. The plurality of sub-pixels SP1, SP2, and SP3 may include a plurality of pixel transistors as shown in FIG. 3. The pixel transistors may be formed via a semiconductor process and may be located on a semiconductor substrate SSUB (see FIG. 7). For example, the pixel transistors may be implemented as a complementary metal oxide semiconductor (CMOS). It should be understood, however, that the embodiments of the present disclosure are not limited thereto.

Each of the sub-pixels SP1, SP2, and SP3 may be connected to one of the write scan lines GWL, one of the control scan lines GCL, one of the bias scan lines GBL, one of the reference scan lines GRL, one of the first emission control lines EL1, one of the second emission control lines EL2, and one of the data lines DL. Each of the sub-pixels SP1, SP2, and SP3 may receive a data voltage from the data line DL according to a write scan signal from the write scan line GWL, and may allow a light-emitting element to emit light according to the data voltage.

The scan driver 610, the emission driver 620, and the data driver 700 may be located in the non-display area NDA.

The scan driver 610 may include a plurality of scan transistors, and the emission driver 620 may include a plurality of light-emitting transistors. The plurality of scan transistors and the plurality of light-emitting transistors may be formed via a semiconductor process and may be formed on the semiconductor substrate SSUB (see FIG. 7). For example, the plurality of scan transistors and the plurality of light-emitting transistors may be formed of a CMOS. It should be understood, however, that the embodiments of the present disclosure are not limited thereto.

The scan driver 610 may include a write scan signal output unit 611, a control scan signal output unit 612, a bias scan signal output unit 613, and a reference scan signal output unit 614. Each of the write scan signal output unit 611, the control scan signal output unit 612, the bias scan signal output unit 613, and the reference scan signal output unit 614 may receive a scan timing control signal SCS from a timing control circuit 400. The write scan signal output unit 611 may generate write scan signals according to the scan timing control signal SCS from the timing control circuit 400 and sequentially output the write scan signals to the write scan lines GWL. The control scan signal output unit 612 may generate control scan signals according to the scan timing control signal SCS and sequentially output the control scan signals to the control scan lines GCL. The bias scan signal output unit 613 may generate bias scan signals according to the scan timing control signal SCS and sequentially output the bias scan signals to the bias scan lines GBL. The reference scan signal output unit 614 may generate reference scan signals according to the scan timing control signal SCS and sequentially output the reference scan signals to the reference scan lines GRL.

The emission driver 620 may include a first emission control driver 621 and a second emission control driver 622. Each of the first emission control driver 621 and the second emission control driver 622 may receive an emission timing control signal ECS from the timing control circuit 400. The first emission control driver 621 may generate first emission control signals according to the emission timing control signal ECS and sequentially output the first emission control signals to the first emission control lines EL1. The second emission control driver 622 may generate second emission control signals according to the emission timing control signal ECS and sequentially output the second emission control signals to the second emission control lines EL2.

The data driver 700 may include a plurality of data transistors, and the plurality of data transistors may be formed via a semiconductor process and may be formed on the semiconductor substrate SSUB (see FIG. 7). For example, a plurality of data transistors may be formed of CMOS transistors. It should be understood, however, that the embodiments of the present disclosure are not limited thereto.

The data driver 700 may receive digital video data DATA and a data timing control signal DCS from the timing control circuit 400. The data driver 700 may convert the digital video data DATA into analog data voltages according to the data timing control signal DCS and may output the analog data voltages to the data lines DL. In doing so, the sub-pixels SP1, SP2, and SP3 may be selected by the write scan signal of the scan driver 610, and data voltages may be applied to the selected sub-pixels SP1, SP2, and SP3.

The heat dissipation layer 200 may overlap with the display panel 100 in a third direction DR3, which is a thickness direction of the display panel 100. The heat dissipation layer 200 may be located on one surface of the display panel 100, e.g., on a rear surface. The heat dissipation layer 200 may serve to release heat generated in the display panel 100. The heat dissipation layer 200 may include a metal layer such as graphite, silver (Ag), copper (Cu) and aluminum (Al) having a high thermal conductivity.

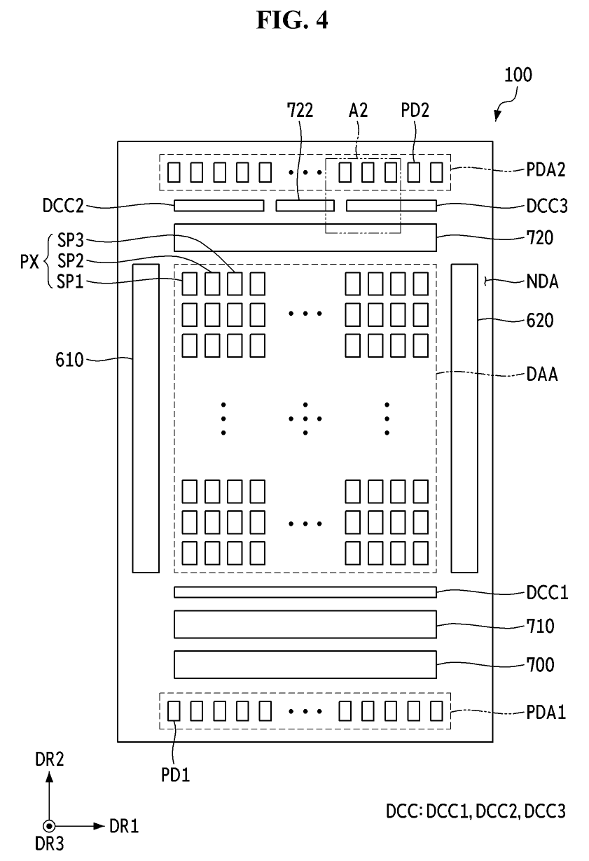

The circuit board 300 may be electrically connected to a plurality of first pads PD1 (see FIG. 4) of a first pad area PDA1 (see FIG. 4) of the display panel 100 using a conductive adhesive member such as an anisotropic conductive film. The circuit board 300 may be a flexible printed circuit board including a flexible material, or a flexible film. Although the circuit board 300 is unfolded in the example shown in FIG. 1, the circuit board 300 may be bent. When the circuit board 300 is bent, a first end portion of the circuit board 300 may be located on the rear surface of the display panel 100 and/or a rear surface of the heat dissipation layer 200. A second end portion of the circuit board 300 may be connected to the plurality of first pads PD1 (see FIG. 4) of the first pad area PDA1 (see FIG. 4) of the display panel 100 using a conductive adhesive member. The first end portion of the circuit board 300 may be opposite to the second end portion of the circuit board 300.

The timing control circuit 400 may receive digital video data and timing signals from an outside. The timing control circuit 400 may generate a scan timing control signal SCS, an emission timing control signal ECS, and a data timing control signal DCS for controlling the display panel 100 in response to the timing signals. The timing control circuit 400 may output the scan timing control signal SCS to the scan driver 610 and output the emission timing control signal ECS to the emission driver 620. The timing control circuit 400 may output the digital video data and the data timing control signal DCS to the data driver 700.

The power supply circuit 500 may generate a plurality of panel driving voltages in response to a power voltage from an outside. For example, the power supply circuit 500 may generate a first driving voltage VSS, a second driving voltage VDD, a third driving voltage VINT, and a fourth driving voltage VREF to apply the first to fourth driving voltages to the display panel 100. The first driving voltage VSS, the second driving voltage VDD, the third driving voltage VINT, and the fourth driving voltage VREF will be described later with reference to FIG. 3.

Each of the timing control circuit 400 and the power supply circuit 500 may be implemented as an integrated circuit (IC) and attached to a surface of the circuit board 300. The scan timing control signal SCS, the emission timing control signal ECS, the digital video data DATA and the data timing control signal DCS from the timing control circuit 400 may be supplied to the display panel 100 through the circuit board 300. The first driving voltage VSS, the second driving voltage VDD, the third driving voltage VINT, and the fourth driving voltage VREF of the power supply circuit 500 may be supplied to the display panel 100 through the circuit board 300.

Alternatively, each of the timing control circuit 400 and the power supply circuit 500 may be located in the non-display area NDA of the display panel 100, similarly to the scan driver 610, the emission driver 620 and the data driver 700. In this instance, the timing control circuit 400 may include a plurality of timing transistors, and each power supply circuit 500 may include a plurality of power transistors. The plurality of timing transistors and the plurality of power transistors may be formed via a semiconductor process and may be formed on the semiconductor substrate SSUB (see FIG. 7). For example, the plurality of timing transistors and the plurality of power transistors may be formed of CMOS transistors. It should be understood, however, that the embodiments of the present disclosure are not limited thereto. Each of the timing control circuit 400 and the power supply circuit 500 may be located between the data driver 700 and the first pad area PDA1 (see FIG. 4).

FIG. 3 is an equivalent circuit diagram of a first sub-pixel according to an embodiment of the present disclosure.

Referring to FIG. 3, a first sub-pixel SP1 may be connected to a write scan line GWL, a control scan line GCL, a bias scan line GBL, a first emission control line EL1, a second emission control line EL2 and a data line DL. In addition, the first sub-pixel SP1 may be connected to a first driving voltage line VSL where the first driving voltage VSS equal to a low-level voltage is applied, a second driving voltage line VDL where the second driving voltage VDD equal to a high-level voltage is applied, a third driving voltage line VIL where the third driving voltage VINT equal to an initialization voltage is applied, and a fourth driving voltage line VRL where the fourth driving voltage VREF equal to a reference voltage is applied. For example, the first driving voltage line VSL may be a low-level voltage line, the second driving voltage line VDL may be a high-level voltage line, the third driving voltage line VIL may be an initialization voltage line, and the fourth driving voltage line VRL may be a reference voltage line. The first driving voltage VSS may be lower than the third driving voltage VINT. The second driving voltage VDD may be higher than the third driving voltage VINT. The fourth driving voltage VREF may be lower than the second driving voltage VDD.

The first sub-pixel SP1 may include a plurality of transistors T1 to T7, a light-emitting element LE, a first capacitor CP1, and a second capacitor CP2.

The light-emitting element LE may emit light according to a driving current Ids flowing in a channel of a first transistor T1. An amount of the light emitted from the light-emitting element LE may be proportional to the driving current Ids. The light-emitting element LE may be located between a fourth transistor T4 and the first driving voltage line VSL. A first electrode of the light-emitting element LE may be connected to a drain electrode of the fourth transistor T4, and a second electrode of the light-emitting element LE may be connected to the first driving voltage line VSL. The first electrode of the light-emitting element LE may be an anode electrode, and the second electrode of the light-emitting element LE may be a cathode electrode. The light-emitting element LE may be an organic light-emitting diode including a first electrode, a second electrode, and an organic light-emitting layer located between the first electrode and the second electrode. It should be understood, however, that the present disclosure is not limited thereto. For example, the light-emitting element LE may be an inorganic light-emitting element including a first electrode, a second electrode, and an inorganic semiconductor located between the first electrode and the second electrode. In this instance, the light-emitting element LE may be a micro light-emitting diode.

The first transistor T1 may be a driving transistor for controlling the source-drain current Ids (hereinafter referred to as "driving current") flowing between a source electrode and a drain electrode thereof according to a voltage applied to a gate electrode thereof. The first transistor T1 may include the gate electrode connected to a first node N1, the source electrode connected to a drain electrode of a sixth transistor T6, and the drain electrode connected to a second node N2.

A second transistor T2 may be located between a first electrode of the first capacitor CP1 and the data line DL. The second transistor T2 may be turned on by a write scan signal from the write scan line GWL and connect the first electrode of the first capacitor CP1 to the data line DL. Accordingly, the data voltage of the data line DL may be applied to the first electrode of the first capacitor CP1. The second transistor T2 may include a gate electrode connected to the write scan line GWL, a source electrode connected to the data line DL, and a drain electrode connected to the first electrode of the first capacitor CP1.

A third transistor T3 may be located between the first node N1 and the second node N2. The third transistor T3 may be turned on by the write control signal of the write control line GCL and connect the first node N1 to the second node N2. Accordingly, if a gate electrode and a source electrode of the first transistor T1 are connected with each other, the first transistor T1 may act like a diode. The third transistor T3 may include the gate electrode connected to the write control line GCL, the source electrode connected to the second node N2, and a drain electrode connected to the first node N1.

The fourth transistor T4 may be connected between the second node N2 and a third node N3. The fourth transistor T4 may be turned on by a first emission control signal of the first emission control line EL1 and connect the second node N2 to the third node N3. Accordingly, the driving current of the first transistor T1 may be supplied to the light-emitting element LE. The fourth transistor T4 may include a gate electrode connected to the first emission control line EL1, a source electrode connected to the second node N2, and a drain electrode connected to the third node N3.

A fifth transistor T5 may be located between the third node N3 and the third driving voltage line VIL. The fifth transistor T5 may turned on by a bias scan signal of the bias scan line GBL and connect the third node N3 to the third driving voltage line VIL. Accordingly, the third driving voltage VINT of the third driving voltage line VIL may be applied to the first electrode of the light-emitting element LE. The fifth transistor T5 may include a gate electrode connected to the bias scan line GBL, a source electrode connected to the third node N3, and a drain electrode connected to the third driving voltage line VIL.

The sixth transistor T6 may be located between the source electrode of the first transistor T1 and the second driving voltage line VDL. The sixth transistor T6 may be turned on by the second emission control signal of the second emission control line EL2 and connect the source electrode of the first transistor T1 to the second driving voltage line VDL. Accordingly, the second driving voltage VDD of the second driving voltage line VDL may be applied to the source electrode of the first transistor T1. The sixth transistor T6 may include a gate electrode connected to the second emission control line EL2, a source electrode connected to the second driving voltage line VDL, and a drain electrode connected to the source electrode of the first transistor T1.

A seventh transistor T7 may be located between the gate electrode (e.g., the first node N1) of the first transistor T1 and the fourth driving voltage line VRL. The seventh transistor T7 may be turned on by the reference scan signal of the reference scan line GRL and connect the gate electrode (e.g., the first node N1) of the first transistor T1 to the fourth driving voltage line VRL. Accordingly, the fourth driving voltage VREF of the fourth driving voltage line VRL may be applied to the gate electrode of the first transistor T1. The seventh transistor T7 may include a gate electrode connected to the reference scan line GRL, a source electrode connected to the first node N1, and a drain electrode connected to the fourth driving voltage line VRL.

The first capacitor CP1 may be formed between the first node N1 and the drain electrode of the second transistor T2. The first capacitor CP1 may include the first electrode connected to the drain electrode of the second transistor T2, and the second electrode connected to the first node N1.

The second capacitor CP2 may be formed between the gate electrode of the driving transistor DT (e.g., the first transistor T1) and the second driving voltage line VDL. The second capacitor CP2 may include a first electrode connected to the gate electrode of the first transistor T1 and a second electrode connected to the second driving voltage line VDL.

The first node N1 may be a contact point where the gate electrode of the first transistor T1, the drain electrode of the third transistor T3, the second electrode of the first capacitor CP1 and the first electrode of the second capacitor CP2 meet. The second node N2 may be a contact point where the drain electrode of the first transistor T1, the source electrode of the third transistor T3 and the source electrode of the fourth transistor T4 meet. The third node N3 may be a contact point where the drain electrode of the fourth transistor T4, the source electrode of the fifth transistor T5, and the first electrode of the light-emitting element LE meet.

Each of the first to seventh transistors T1 to T7 may be a metal-oxide-semiconductor field effect transistor (MOSFET). For example, each of the first to seventh transistors T1 to T7 may be, but is not limited to, a p-type MOSFET. Each of the first to seventh transistors T1 to T7 may be an n-type MOSFET. Alternatively, some of the first to seventh transistors T1 to T7 may be p-type MOSFETs, and the other transistors may be n-type MOSFETs.

Although the first sub-pixel SP1 includes the seven transistors T1 to T7 and the two capacitors CP1 and CP2 in the example shown in FIG. 3, the equivalent circuit diagram of the first sub-pixel SP1 is not limited to that shown in FIG. 3. For example, numbers of the transistors and the capacitors included in the first sub-pixel SP1 may be variously modified.

In addition, an equivalent circuit diagram of the second sub-pixel SP2 and an equivalent circuit diagram of the third sub-pixel SP3 may be substantially identical to the equivalent circuit diagram of the first sub-pixel SP1 described above with reference to FIG. 3; and, therefore, the redundant descriptions will be omitted.

FIG. 4 is a view showing an example of a layout of a display panel according to an embodiment of the present disclosure.

Referring to FIG. 4, the display area DAA of the display panel 100 according to an embodiment may include a plurality of pixels PX arranged in a matrix. The non-display area NDA of the display panel 100 according to an embodiment may include the scan driver 610, the emission driver 620, the data driver 700, a first distribution circuit 710, a second distribution circuit 720, a decoder 722, a decoupling circuit DCC, the first pad area PDA1, and a second pad area PDA2.

The scan driver 610 may be located on a first side of the display area DAA, and the emission driver 620 may be located on a second side of the display area DAA. For example, the scan driver 610 may be located on one side of the display area DAA in the first direction DR1, and the emission driver 620 may be located on an opposite side of the display area DAA in the first direction DR1. For example, the scan driver 610 may be located on a left side of the display area DAA, and the emission driver 620 may be located on a right side of the display area DAA. It should be understood, however, that the embodiments of the present disclosure are not limited thereto. The scan driver 610 and the emission driver 620 may be located on both the first and second sides of the display area DAA.

The first pad area PDA1 may include the plurality of first pads PD1 connected to pads or bumps of the circuit board 300 through a conductive adhesive member. The first pad area PDA1 may be located on a third side of the display area DAA. For example, the first pad area PDA1 may be located on one side of the display area DAA in the second direction DR2. The first pad area PDA1 may be located on an outer side of the data driver 700 in the second direction DR2 (e.g., negative (-) second direction DR2). That is to say, the first pad area PDA1 may be located closer to an edge of the display panel 100 than the data driver 700 is.

The second pad area PDA2 may include a plurality of second pads PD2 which are inspection pads for inspecting whether the display panel 100 operates normally. The plurality of second pads PD2 may be connected to a jig or a probe pin during an inspection process, or may be connected to a circuit board for inspection. The circuit board for testing may be a printed circuit board including a rigid material or a flexible printed circuit board including a flexible material.

The second pad area PDA2 may be located on a fourth side of the display area DAA. For example, the second pad area PDA2 may be located on an opposite side of the display area DAA in the second direction DR2. The second pad area PDA2 may be located on the outer side of the second distribution circuit 700 in the second direction DR2 (e.g., positive (+) second direction DR2). That is to say, the second pad area PDA2 may be located closer to an edge of the display panel 100 than the second distribution circuit 720.

The first distribution circuit 710 may distribute data voltages applied via the first pad area PDA1 to the plurality of data lines DL. For example, the first distribution circuit 710 may divide the data voltages applied via one first pad PD1 of the first pad area PDA1 into P data lines DL, thereby reducing a number of the plurality of first pads PD1, where P is a positive integer equal to or greater than two. The first distribution circuit 710 may be located on the third side of the display area DAA of the display panel 100. For example, the first distribution circuit 710 may be located on one side of the display area DAA in the second direction DR2 (e.g., negative (-) second direction DR2). That is to say, the first distribution circuit 710 may be located on a lower side of the display area DAA.

The second distribution circuit 720 may distribute signals applied through the second pad area PDA2 to the scan driver 610, the emission driver 620, and the data lines DL. The second pad area PDA2 and the second distribution circuit 720 may be elements to inspect the operation of each of the pixels PX in the display area DAA. The second distribution circuit 720 may be located on the fourth side of the display area DAA of the display panel 100. For example, the second distribution circuit 720 may be located on the opposite side of the display area DAA in the second direction DR2 (e.g., positive (+) second direction DR2). That is to say, the second distribution circuit 720 may be located on an upper side of the display area DAA.

The decoder 722 may be located between the second distribution circuit 720 and the second pad area PDA2. The decoder 722 may be connected to the second distribution circuit 720 and the second pads PD2.

The decoupling circuit DCC may be connected to driving lines connected to the sub-pixels SP1, SP2, and SP3 to reduce a noise of the display panel 100. For example, the decoupling circuit DCC may be connected to the third driving voltage line VIL to minimize a noise and a voltage drop of the third driving voltage VINT applied to the sub-pixels SP1, SP2, and SP3. Specifically, the decoupling circuit DCC may be connected between the third driving voltage line VIL and the first driving voltage line VSL.

The third driving voltage line VIL may be provided to lines separated for each of the sub-pixels SP1, SP2, and SP3, and in such case, the decoupling circuit DCC may be connected to each third driving voltage line VIL of each of the sub-pixels SP1, SP2, and SP3. For example, the third driving voltage line VIL may include a third-first driving voltage line connected to the fifth transistor T5 of the first sub-pixel SP1, a third-second driving voltage line connected to the fifth transistor T5 of the second sub-pixel SP2, and a third-third driving voltage line connected to the fifth transistor T5 of the third sub-pixel SP3, and the decoupling circuit DCC may be connected to each of the third-first driving voltage line, the third-second driving voltage line, and the third-third driving voltage line. Specifically, the decoupling circuit DCC may be connected between the third-first driving voltage line and the first driving voltage line VSL, between the third-second driving voltage line and the first driving voltage line VSL, and between the third-third driving voltage line and the first driving voltage line VSL.

The decoupling circuit DCC may be connected to the fourth driving voltage line VRL to minimize a noise and a voltage drop of the fourth driving voltage VREF applied to the sub-pixels SP1, SP2, and SP3. Specifically, the decoupling circuit DCC may be connected between the fourth driving voltage line VRL and the first driving voltage line VSL.

The decoupling circuit DCC may include a plurality of decoupling circuits DCC1, DCC2, and DDC3 located in different areas in the non-display area NDA of the display panel 100. For example, the decoupling circuit DCC may include a first decoupling circuit DCC1, a second decoupling circuit DCC2, and a third decoupling circuit DCC3.

The first decoupling circuit DCC1 may be located between the display area DAA and the first distribution circuit 710. The data driver 700 which is in the non-display area NDA may be adjacent to a first edge of the display area DAA. The first decoupling circuit DCC1 which is in the non-display area NDA may be adjacent to the first edge of the display area, and the second and third decoupling circuits DCC2, DCC3 which are in the non-display area NDA may be adjacent to a second edge of the display area DAA, the first edge being opposite to the second edge. The first decoupling circuit DCC1 may be connected to the sub-pixels SP1, SP2, and SP3 of the display area DAA. The first decoupling circuit DCC1 may be connected between the third driving voltage line VIL and the first driving voltage line VSL and between the fourth driving voltage line VRL and the first driving voltage line VSL. In addition, the first decoupling circuit DCC1 may be connected between the third-first driving voltage line and the first driving voltage line VSL, between the third-second driving voltage line and the first driving voltage line VSL, and between the third-third driving voltage line and the first driving voltage line VSL.

The second decoupling circuit DCC2 may be located between the second distribution circuit 720 and the second pad PD2. The second decoupling circuit DCC2 may be connected to the sub-pixels SP1, SP2, and SP3 of the display area DAA. The second decoupling circuit DCC2 may be connected between the third driving voltage line VIL and the first driving voltage line VSL and between the fourth driving voltage line VRL and the first driving voltage line VSL. In addition, the second decoupling circuit DCC2 may be connected between the third-first driving voltage line and the first driving voltage line VSL, between the third-second driving voltage line and the first driving voltage line VSL, and between the third-third driving voltage line and the first driving voltage line VSL.

The third decoupling circuit DCC3 may be located between the second distribution circuit 720 and the second pad PD2. The third decoupling circuit DCC3 may be connected to the sub-pixels SP1, SP2, and SP3 of the display area DAA. The third decoupling circuit DCC3 and the second decoupling circuit DCC2 may face each other with the decoder 722 interposed therebetween. For example, the decoder 722 may be located between the second decoupling circuit DCC2 and the third decoupling circuit DCC3. The third decoupling circuit DCC3 may be connected between the third driving voltage line VIL and the first driving voltage line VSL and between the fourth driving voltage line VRL and the first driving voltage line VSL. In addition, the third decoupling circuit DCC3 may be connected between the third-first driving voltage line and the first driving voltage line VSL, between the third-second driving voltage line and the first driving voltage line VSL, and between the third-third driving voltage line and the first driving voltage line VSL.

According to an embodiment, as the plurality of decoupling circuits DCC1 to DCC3 are located in the non-display area NDA, a noise and a voltage drop of the driving voltage described above may be minimized. In particular, since the second decoupling circuit DCC2 and the third decoupling circuit DCC3 are located in an area with relatively less wiring compared to the first decoupling circuit DCC1, each of the second decoupling circuit DCC2 and the third decoupling circuit DCC3 may have a greater size than the first decoupling circuit DCC1. For example, the first decoupling circuit DCC1 located adjacent to the data driver 700 may not have a large size due to many wires connected to the data driver 700. However, since the data driver 700 is not located in the peripheral area of the second distribution circuit 720, a relatively smaller number of wirings may be placed between the second distribution circuit 720 and the second pad PD2. Accordingly, the second decoupling circuit DCC2 and the third decoupling circuit DCC3 may be greater in size than the first decoupling circuit DCC1.

As described above, as the second decoupling circuit DCC2 and the third decoupling circuit DCC3 are located between the second distribution circuit 720 and the second pad PD2, a noise and a voltage drop of the driving voltage may be minimized.

The first decoupling circuit DCC1 among the above-described first to third decoupling circuits DCC1 to DCC3 may be omitted.

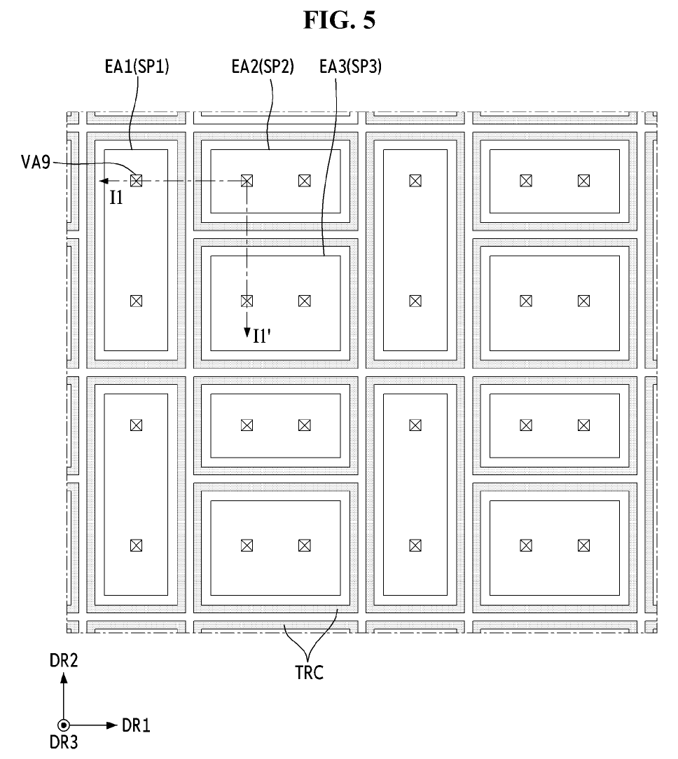

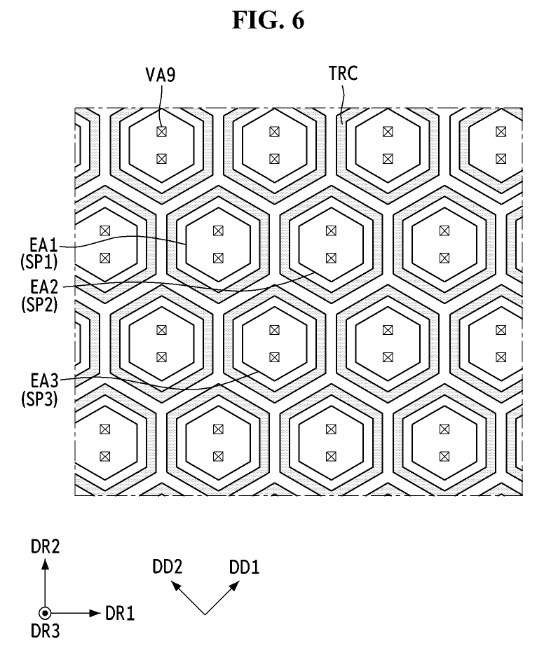

FIGS. 5 and 6 are views showing examples of the layout of the display area of FIG. 4.

Referring to FIGS. 5 and 6, each of the plurality of pixels PX may include a first emission area EA1 that is an emission area of the first sub-pixel SP1, a second emission area EA2 that is an emission area of the second sub-pixel SP2, and a third emission area EA3 that is an emission area of the third sub-pixel SP3.

Each of the first emission area EA1, the second emission area EA2 and the third emission area EA3 may have a polygonal shape, a circular shape, an elliptical shape or an irregular shape when viewed from the top.

A maximum length of the first emission area EA1 in the first direction DR1 may be smaller than a maximum length of the second emission area EA2 in the first direction DR1 and a maximum length of the third emission area EA3 in the first direction DR1. The maximum length of the second emission area EA2 in the first direction DR1 may be substantially equal to the maximum length of the third emission area EA3 in the first direction DR1.

A maximum length of the first emission area EA1 in the second direction DR2 may be greater than a maximum length of the second emission area EA2 in the second direction DR2 and a maximum length of the third emission area EA3 in the second direction DR2. The maximum length of the second emission area EA2 in the second direction DR2 may be less than the maximum length of the third emission area EA3 in the second direction DR2. In another embodiment, the maximum length of the first emission area EA1 in the second direction DR2 may be smaller than the maximum length of the second emission area EA2 in the second direction DR2.

The first emission area EA1, the second emission area EA2 and the third emission area EA3 may have a hexagonal shape consisting of six straight lines as shown in FIG. 6 when viewed from the top. It should be understood, however, that the embodiments of the present disclosure are not limited thereto. The first emission area EA1, the second emission area EA2 and the third emission area EA3 may have a polygonal shape other than a hexagon, a circular shape, an elliptical shape or an irregular shape when viewed from the top.

As shown in FIG. 5, in each of the plurality of pixels PX, the first emission area EA1 and the second emission area EA2 may be adjacent to each other in the first direction DR1. In addition, the first emission area EA1 and the third emission area EA3 may be adjacent to each other in the first direction DR1. In addition, the second emission area EA2 and the third emission area EA3 may be adjacent to each other in the second direction DR2. The first emission area EA1, the second emission area EA2 and the third emission area EA3 may have different areas.

Alternatively, as shown in FIG. 6, the first emission area EA1 and the second emission area EA2 may be adjacent to each other in the first direction DR1, the second emission area EA2 and the third emission area EA3 may be adjacent to each other in a first diagonal direction DD1, and the first emission area EA1 and the third emission area EA3 may be adjacent to each other in a second diagonal direction DD2. The first diagonal direction DD1 refers to a direction between the first direction DR1 and the second direction DR2, and refers to a direction inclined by 45 degrees relative to the first direction DR1 and the second direction DR2. The second diagonal direction DD2 may be orthogonal to the first diagonal direction DD1.

The first sub-pixel SP1 may output a first light that has passed through a first color filter CF1 (see FIG. 7) from among lights output from the first emission area EA1, the second sub-pixel SP2 may output a second light that has passed through a second color filter CF2 (see FIG. 7) from among lights output from the second emission area EA2, and the third sub-pixel SP3 may output a third light that has passed through a third color filter CF3 (see FIG. 7) from among lights output from the third emission area EA3. One of the first to third lights may be light in a blue wavelength range, another light may be light in a green wavelength range, and the other light may be light in a red wavelength range. For example, the blue wavelength range may refer that a main peak wavelength of light lies in a wavelength range of approximately 370 nm to 460 nm, the green wavelength range may refer that the main peak wavelength of light lies in a wavelength range of approximately 480 nm to 560 nm, and the red wavelength range may refer to that the main peak wavelength of light lies in a wavelength range of approximately 600 nm to 750 nm.

Although each of the plurality of pixels PX includes three emission areas EA1, EA2, and EA3 in the example shown in FIGS. 5 and 6, the embodiments of the present disclosure are not limited thereto. For example, each of the plurality of pixels PX may include four emission areas.

In addition, the layout of the emission areas of the plurality of pixels PX is not limited to that shown in FIGS. 5 and 6. For example, the emission areas of the plurality of pixels PX may have a stripe structure in which the emission areas are arranged in the first direction DR1, a PenTile^{®} matrix in which the emission areas have a diamond arrangement, or a hexagonal structure in which emission areas having a hexagonal shape when viewed from the top are arranged as shown in FIG. 6.

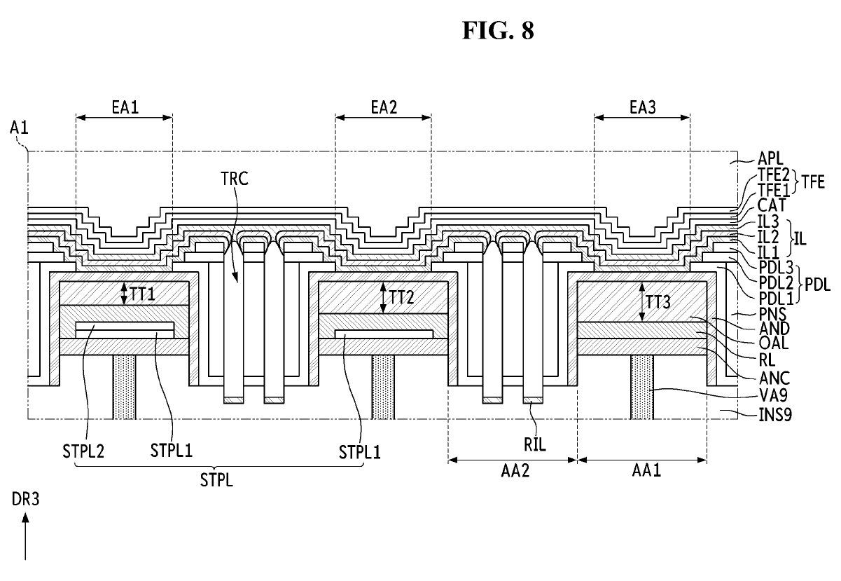

FIG. 7 is a cross-sectional view showing an example of the display panel taken along line I1 – I1’ of FIG. 5. FIG. 8 is a cross-sectional view showing area A1 of FIG. 7 in detail.

Referring to FIGS. 7 and 8, the display panel 100 may include a semiconductor backplane SBP, a light-emitting element backplane EBP, a display element layer EML, an encapsulation layer TFE, an optical layer OPL, a cover layer CVL, and a polarizing plate POL.

The semiconductor backplane SBP may include a semiconductor substrate SSUB including a plurality of pixel transistors PTR, a plurality of semiconductor insulating layers covering the plurality of pixel transistors PTR, and a plurality of contact terminals CTE that are electrically connected to the pixel transistors PTR, respectively. The plurality of pixel transistors PTR may be the first to seventh transistors T1 to T7 described above with reference to FIG. 3.

The semiconductor substrate SSUB may be a silicon substrate, a germanium substrate, or a silicon-germanium substrate. The semiconductor substrate SSUB may be a substrate doped with first-type impurities. A plurality of well areas WA may be arranged in an upper surface of the semiconductor substrate SSUB. The well areas WA may be doped with second-type impurities. The second-type impurities may be different from the first-type impurities. For example, when the first-type impurities are p-type impurities, the second-type impurities may be n-type impurities. Alternatively, when the first-type impurities are n-type impurities, the second-type impurities may be p-type impurities.

Each of the well areas WA may include a source region SA associated with a source electrode of a pixel transistor PTR, a drain region DA associated with a drain electrode thereof, and a channel region CH between the source region SA and the drain region DA.

A bottom insulating layer BINS may be located between the gate electrode GE and the well areas WA. Side insulating layers SINS may be located on side surfaces of the gate electrode GE. The side insulating layers SINS may be located on the bottom insulating layer BINS.

Each of the source region SA and the drain region DA may be doped with the first-type impurities. The gate electrode GE of the pixel transistor PTR may overlap with the well area WA in the third direction DR3 which is the thickness direction of the semiconductor substrate SSUB. The channel region CH may overlap with the gate electrode GE in the third direction DR3. The source region SA may be located on one side of the gate electrode GE, and the drain region DA may be located on an opposite side of the gate electrode GE.

Each of the plurality of well areas WA may further include a first low-concentration impurity region LDD1 located between the channel region CH and the source region SA, and a second low-concentration impurity region LDD2 located between the channel region CH and the drain region DA. The first low-concentration impurity region LDD1 may have a lower impurity concentration than the source region SA due to the bottom insulating layer BINS. The second low-concentration impurity region LDD2 may have a lower impurity concentration than the drain region DA due to the bottom insulating layer BINS. A distance between the source region SA and the drain region DA may be increased by the first low-concentration impurity region LDD1 and the second low-concentration impurity region LDD2. Therefore, a length of the channel region CH of each of the pixel transistors PTR may be increased, and thus it is possible to prevent punch-through and a hot carrier phenomenon due to a short channel.

A first semiconductor insulating layer SINS1 may be located on the semiconductor substrate SSUB. The first semiconductor insulating layer SINS1 may be formed of, but is not limited to, a silicon carbon nitride (SiCN) or a silicon oxide (SiOx)-based inorganic film.

A second semiconductor insulating layer SINS2 may be located on the first semiconductor insulating layer SINS1. The second semiconductor insulating layer SINS2 may be formed of a silicon oxide (SiOx)-based inorganic film, but the embodiments of the present disclosure are not limited thereto.

A plurality of contact terminals CTE may be located on the second semiconductor insulating layer SINS2. Each of the plurality of contact terminals CTE may be connected to one of the gate electrode GE, the source region SA and the drain region DA of each of the pixel transistors PTR through a hole penetrating the first semiconductor insulating layer SINS1 and the second semiconductor insulating layer SINS2. The contact terminals CTE may include one of copper (Cu), aluminum (Al), tungsten (W), molybdenum (Mo), chromium (Cr), gold (Au), titanium (Ti), nickel (Ni) and neodymium (Nd), or an alloy containing one of these.

A third semiconductor insulating layer SINS3 may be located on a side surface of each of the contact terminals CTE. An upper surface of each of the contact terminals CTE may not be covered by the third semiconductor insulating layer SINS3 but may be exposed. The third semiconductor insulating layer SINS3 may be formed of a silicon oxide (SiOx)-based inorganic film, but the embodiments of the present disclosure are not limited thereto.

The semiconductor substrate SSUB may be replaced with a glass substrate or a polymer resin substrate such as polyimide. In this instance, thin-film transistors may be arranged on a glass substrate or a polymer resin substrate. The glass substrate may be a rigid substrate that is not bent, while the polymer resin substrate may be a flexible substrate that may be bent or curved.

The light-emitting element backplane EBP may include a plurality of conductive layers ML1 to ML8, a plurality of via electrodes VA1 to VA9, and a plurality of insulating layers INS1 to INS9. The light-emitting element backplane EBP may include a first to a ninth electrodes VA1 to VA9, and the light-emitting element backplane EBP may include a first to ninth insulating layers INS1 to INS9 arranged between a first to eighth conductive layers ML1 to ML8.

The first to eighth conductive layers ML1 to ML8 may implement a circuit of the first sub-pixel SP1 shown in FIG. 4 by connecting the plurality of contact terminals CTE exposed from the semiconductor backplane SBP. For example, the first to seventh transistors T1 to T7 may be formed only in the semiconductor backplane SBP, and the connection of the first to seventh transistors T1 to T7 and the first capacitor CP1 and the second capacitor CP2 may be made through the first to eighth conductive layers ML1 to ML8. In addition, the connection between a drain region corresponding to the drain electrode of the fourth transistor T4, a source region corresponding to the source electrode of the fifth transistor T5, and a first electrode AND of the light-emitting element LE may also be made through the first to eighth conductive layers ML1 to ML8.

The first insulating layer INS1 may be located on the semiconductor backplane SBP. Each of the first via electrodes VA1 may penetrate the first insulating layer INS1 and may be connected to the contact terminal CTE exposed from the semiconductor backplane SBP. Each of the first conductive layers ML1 may be arranged on the first insulating layer INS1 and may be connected to the first via electrode VA1.

The second insulating layer INS2 may be located on the first insulating layer INS1 and the first conductive layers ML1. Each of the second via electrodes VA2 may penetrate through the second insulating layer INS2 to be connected to the exposed first conductive layer ML1. Each of the second conductive layers ML2 may be located on the second insulating layer INS2 and may be connected to the second via electrode VA2.

The third insulating layer INS3 may be located over the second insulating layer INS2 and the second conductive layers ML2. Each of the third via electrodes VA3 may penetrate through the third insulating layer INS3 to be connected to the exposed second conductive layer ML2. Each of the third conductive layers ML3 may be located on the third insulating layer INS3 and may be connected to the third via electrode VA3.

The fourth insulating layer INS4 may be located over the third insulating layer INS3 and the third conductive layers ML3. Each of the fourth via electrodes VA4 may penetrate through the fourth insulating layer INS4 to be connected to the exposed third conductive layer ML3. Each of the fourth conductive layers ML4 may be located on the fourth insulating layer INS4 and may be connected to the fourth via electrode VA4.

The fifth insulating layer INS5 may be located over the fourth insulating layer INS4 and the fourth conductive layers ML4. Each of the fifth via electrodes VA5 may penetrate through the fifth insulating layer INS5 to be connected to the exposed fourth conductive layer ML4. Each of the fifth conductive layers ML5 may be located on the fifth insulating layer INS5 and may be connected to the fifth via electrode VA5.

The sixth insulating layer INS6 may be located over the fifth insulating layer INS5 and the fifth conductive layers ML5. Each of the sixth via electrodes VA6 may penetrate through the sixth insulating layer INS6 to be connected to the exposed fifth conductive layer ML5. Each of the sixth conductive layers ML6 may be located on the sixth insulating layer INS6 and may be connected to the sixth via electrode VA6.

The seventh insulating layer INS7 may be located over the sixth insulating layer INS6 and the sixth conductive layers ML6. Each of the seventh via electrodes VA7 may penetrate through the seventh insulating layer INS7 to be connected to the exposed sixth conductive layer ML6. Each of the seventh conductive layers ML7 may be located on the seventh insulating layer INS7 and may be connected to the seventh via electrode VA7.

The eighth insulating layer INS8 may be located over the seventh insulating layer INS7 and the seventh conductive layers ML7. Each of the eighth via electrodes VA8 may penetrate through the eighth insulating layer INS8 to be connected to the exposed seventh conductive layer ML7. Each of the eighth conductive layers ML8 may be located on the eighth insulating layer INS8 and may be connected to the eighth via electrode VA8.

The first to eighth conductive layers ML1 to ML8 and the first to eighth via electrodes VA1 to VA8 may include substantially the same material. The first to eighth conductive layers ML1 to ML8 and the first to eighth via electrodes VA1 to VA8 may include one of copper (Cu), aluminum (Al), tungsten (W), molybdenum (Mo), chromium (Cr), gold (Au), titanium (Ti), nickel (Ni) and neodymium (Nd), or an alloy containing one of these. The first to eighth via electrodes VA1 to VA8 may include substantially the same material. The first to eighth insulating layers INS1 to INS8 may be formed of a silicon oxide (SiOx)-based inorganic film, but the embodiments of the present disclosure are not limited thereto.

A thickness of the first conductive layer ML1, a thickness of the second conductive layer ML2, a thickness of the third conductive layer ML3, a thickness of the fourth conductive layer ML4, a thickness of the fifth conductive layer ML5 and a thickness of the sixth conductive layer ML6 may be greater than a thickness of the first via electrode VA1, a thickness of the second via electrode VA2, a thickness of the third via electrode VA3, a thickness of the fourth via electrode VA4, a thickness of the fifth via electrode VA5 and a thickness of the sixth via electrode VA6. The thickness of the second conductive layer ML2, the thickness of the third conductive layer ML3, the thickness of the fourth conductive layer ML4, the thickness of the fifth conductive layer ML5, and the thickness of the sixth conductive layer ML6 may be greater than the thickness of the first conductive layer ML1. The thickness of the second conductive layer ML2, the thickness of the third conductive layer ML3, the thickness of the fourth conductive layer ML4, the thickness of the fifth conductive layer ML5 and the thickness of the sixth conductive layer ML6 may be substantially all equal. For example, the thickness of the first conductive layer ML1 may be approximately 1,360 Å, the thickness of the second conductive layer ML2, the thickness of the third conductive layer ML3, the thickness of the fourth conductive layer ML4, the thickness of the fifth conductive layer ML5 and the thickness of the sixth conductive layer ML6 may be approximately 1,440 Å, and the thickness of the first via electrode VA1, the thickness of the second via electrode VA2, the thickness of the third via electrode VA3, the thickness of the fourth via electrode VA4, the thickness of the fifth via electrode VA5 and the thickness of the sixth via electrode VA6 may be approximately 1,150 Å.

A thickness of the seventh conductive layer ML7 and a thickness of the eighth conductive layer ML8 may be greater than the thickness of the first conductive layer ML1, the thickness of the second conductive layer ML2, the thickness of the third conductive layer ML3, the thickness of the fourth conductive layer ML4, the thickness of the fifth conductive layer ML5 and the thickness of the sixth conductive layer ML6. The thickness of the seventh conductive layer ML7 and the thickness of the eighth conductive layer ML8 may be greater than a thickness of the seventh via electrode VA7 and a thickness of the eighth via electrode VA8. The thickness of the seventh via electrode VA7 and the thickness of the eighth via electrode VA8 may be greater than the thickness of the first via electrode VA1, the thickness of the second via electrode VA2, the thickness of the third via electrode VA3, and the thickness of the fourth via electrode VA4, the thickness of the fifth via electrode VA5 and the thickness of the sixth via electrode VA6. The thickness of the seventh conductive layer ML7 may be substantially equal to the thickness of the eighth conductive layer ML8. For example, the thickness of the seventh conductive layer ML7 and the thickness of the eighth conductive layer ML8 may be approximately 9,000 Å. The thickness of the seventh via electrode VA7 and the thickness of the eighth via electrode VA8 may be approximately 6,000 Å.

The ninth insulating layer INS9 may be located over the eighth insulating layer INS8 and the eighth conductive layer ML8. The ninth insulating layer INS9 may be formed of a silicon oxide (SiOx)-based inorganic film, but the embodiments of the present disclosure are not limited thereto.

Each of the ninth via electrodes VA9 may penetrate through the ninth insulating layer INS9 to be connected to the exposed eighth conductive layer ML8. The ninth via electrodes VA9 may include one of copper (Cu), aluminum (Al), tungsten (W), molybdenum (Mo), chromium (Cr), gold (Au), titanium (Ti), nickel (Ni) and neodymium (Nd), or an alloy containing one of these. A thickness of the ninth via electrode VA9 may be approximately 16,500 Å.

The display element layer EML may be located on the light-emitting element backplane EBP. The display element layer EML may include a plurality of connection electrodes ANC, a plurality of reflective electrodes RL, a planarization film PNS, a pixel-defining layer PDL, a plurality of first electrodes AND, an emission stack IL, a second electrode CAT, and a plurality of trenches TRC.

In addition, the display element layer EML may include a first emission area EA1, a second emission area EA2, and a third emission area EA3. In each of the first emission area EA1, the second emission area EA2 and the third emission area EA3, the first electrode AND, the emission stack IL and the second electrode CAT may be sequentially stacked on one another. In each of the first emission area EA1, the second emission area EA2 and the third emission area EA3, a light-emitting element LE including the first electrode AND, the emission stack IL, and the second electrode CAT is located. Each of the first emission areas EA1, the second emission areas EA2 and the third emission areas EA3 may be defined by a first pixel-defining layer PDL1.

The ninth insulating layer INS9 may include first areas AA1 in line with the connection electrodes ANC, and second areas AA2 arranged around the first areas AA1. A thickness of the first areas AA1 of the ninth insulating layer INS9 (or a thickness of the ninth insulating layer INS9 in the first area AA1) may be greater than a thickness of the second areas AA2 of the ninth insulating layer INS9 (or a thickness of the ninth insulating layer INS9 in the first area AA2).

The connection electrodes ANC may be arranged on the first areas AA1 of the ninth insulating layer INS9, respectively. Each of the connection electrodes ANC may be arranged on a corresponding first areas AA1. Each of the connection electrodes ANC may include titanium nitride (TiN) or a transparent conductive oxide. For example, the transparent conductive oxide may be, but is not limited to, indium tin oxide (ITO) or indium zinc oxide (IZO).

A step layer STPL may include a first step layer STPL1 and a second step layer STPL2. The first step layer STPL1 and the second step layer STPL2 may be formed of, but is not limited to, a silicon carbon nitride (SiCN) or a silicon oxide (SiOx)-based inorganic film.

The first step layer STPL1 may be located on the connection electrode ANC in each of the first sub-pixels SP1 and the second sub-pixels SP2. In addition, the second step layer STPL2 may be arranged on the first step layer STPL1 in each of the first sub-pixels SP1. No step layer STPL may be disposed in each of the third sub-pixels SP3.

In each of the first sub-pixels SP1, the reflective electrode RL may be disposed on the connection electrode ANC, the first step layer STPL1 and the second step layer STPL2. For example, in each of the first sub-pixels SP1, the reflective electrode RL may cover an upper surface of the connection electrode ANC, side surfaces of the first step layer STPL1, and an upper surface and side surfaces of the second step layer STPL2.

In each of the second sub-pixels SP2, the reflective electrode RL may be located on the connection electrode ANC and the first step layer STPL1. For example, in each of the second sub-pixels SP2, the reflective electrode RL may cover the upper surface of the connection electrode ANC, and an upper surface and the side surfaces of the first step layer STPL1.

In each of the third sub-pixels SP3, the reflective electrode RL may be located on the connection electrode ANC. For example, in each of the third sub-pixels SP3, the reflective electrode RL may cover the upper surface of the connection electrode ANC.

Each of the reflective electrodes RL may include one of copper (Cu), aluminum (Al), tungsten (W), molybdenum (Mo), chromium (Cr), gold (Au), titanium (Ti), nickel (Ni) and neodymium (Nd), or an alloy containing one of these. For example, each of the reflective electrodes RL may include aluminum (Al) having high reflectivity.

A plurality of optical auxiliary layers OAL may be located on the reflective electrodes RL, respectively. The optical auxiliary layers OAL may be associated with the reflective electrodes RL, respectively. The optical auxiliary layers OAL may be formed of a silicon oxide (SiOx)-based inorganic film, but the embodiments of the present disclosure are not limited thereto.

Due to the first step layer STPL1 and the second step layer STPL2, a thickness TT1 of the optical auxiliary layer OAL in the first sub-pixel SP1, a thickness TT2 of the optical auxiliary layer OAL in the second sub-pixel SP2, and a thickness TT3 of the optical auxiliary layer OAL in the third sub-pixel SP3 may be different from one another. For example, due to the first step layer STPL1 and the second step layer STPL2, the thickness TT1 of the optical auxiliary layer OAL in the first sub-pixel SP1 may be the smallest. In addition, the thickness TT3 of the optical auxiliary layer OAL may be the largest in the third sub-pixel SP3 where the first step layer STPL1 and the second step layer STPL2 are not provided. The thickness TT1 of the optical auxiliary layer OAL in the first sub-pixel SP1 may be smaller than the thickness TT2 of the optical auxiliary layer OAL in the second sub-pixel SP2. In addition, the thickness TT1 of the optical auxiliary layer OAL in the first sub-pixel SP1 may be smaller than the thickness TT3 of the optical auxiliary layer OAL in the third sub-pixel SP3. In addition, the thickness TT2 of the optical auxiliary layer OAL in the second sub-pixel SP2 may be smaller than the thickness TT3 of the optical auxiliary layer OAL in the third sub-pixel SP3.

A thickness of the first step layer STPL1 may be equal to or different from a thickness of the second step layer STPL2. Depending on whether the first step layer STPL1 and/or the second step layer STPL2 are provided and depending on the thickness of the first step layer STPL1 and/or the second step layer STPL2 provided, the thickness TT1 of the optical auxiliary layer OAL in the first sub-pixel SP1, the thickness TT2 of the optical auxiliary layer OAL in the second sub-pixel SP2, and the thickness TT3 of the optical auxiliary layer OAL in the third sub-pixel SP3 may be different from one another. Therefore, the thickness TT1 of the first step layer STPL1 and the thickness TT2 of the second step layer STPL2 may be determined based on the main peak wavelength of the first light, the main peak wavelength of the second light, the main peak wavelength of the third light, a distance from a first stack layer IL1 to the reflective electrode RL in the first emission area EA1, and a distance from a second stack layer IL2 to the reflective electrode RL in the second emission area EA2. Based on the thicknesses TT1 and TT2, a resonance distance of the first light, a resonance distance of the second light, and a resonance distance of the third light may be determined.

Although two step layers, e.g., the first step layer STPL1 and the second step layer STPL2 are shown in FIGS. 7 and 8, the embodiments of the present disclosure are not limited thereto. If the resonance distance of the first light, the resonance distance of the second light and the resonance distance of the third light may be optimally designed only with one step layer, either the first step layer STPL1 or the second step layer STPL2 may be eliminated.

In addition, although the first step layer STPL1 is disposed in the first sub-pixel SP1 and the second sub-pixel SP2, and the second step layer STPL2 are disposed in the first sub-pixel SP1 in FIGS. 7 and 8, the embodiments of the present disclosure are not limited thereto. Positions of the first step layer STPL1 and the second step layer STPL2 may be determined based on the main peak wavelength of the first light, the main peak wavelength of the second light, the main peak wavelength of the third light, the distance from the first stack layer IL1 to the reflective electrode RL in the first emission area EA1, and the distance from the second stack layer IL2 to the reflective electrode RL in the second emission area EA2.

Each of the light-emitting elements LE may include the first electrode AND, the emission stack IL, and the second electrode CAT.

The first electrode AND of each of the light-emitting elements LE may be arranged on the side surfaces of the connection electrode ANC, the side surfaces of the reflective electrode RL, and the upper surface and the side surfaces of the optical auxiliary layer OAL. Since the first electrode AND of each of the light-emitting elements LE comes in contact with and is electrically connected to the side surfaces of the reflective electrode RL and the side surfaces of the connection electrode ANC, it is possible to reduce mask processes compared to the structure in which the first electrode AND of each of the light-emitting elements LE is connected to the reflective electrode RL exposed through a hole penetrating the optical auxiliary layer OAL. In addition, the fabrication cost may be saved and the fabrication efficiency may be increased.

In addition, since the thickness of the ninth insulating layer INS9 is greater in the first area AA1 than in the second area AA2, the ninth insulating layer INS9 may be partially exposed in the first area AA1. Therefore, the first electrode AND of each of the light-emitting elements LE may be located on a part of the ninth insulating layer INS9 in the first area AA1. Accordingly, a length of the first electrode AND in the third direction DR3 may be greater than a sum of a length of the side surfaces of the connection electrode ANC, a length of the side surfaces of the reflective electrode RL, and a length of the side surfaces of the optical auxiliary layer OAL.

The first electrode AND of each of the light-emitting elements LE may be connected to the drain region DA or the source region SA of the pixel transistor PTR through the connection electrode ANC, the first to ninth via electrodes VA1 to VA9, the first to eighth conductive layers ML1 to ML8 and the contact terminal CTE.

The first electrode AND of each of the light-emitting elements LE may include one of copper (Cu), aluminum (Al), tungsten (W), molybdenum (Mo), chromium (Cr), gold (Au), titanium (Ti), nickel (Ni) and neodymium (Nd), or an alloy containing one of these. For example, the first electrode AND of each of the light-emitting elements LE may be titanium nitride (TiN).

A thickness of the first electrode AND located on an upper surface of the optical auxiliary layer OAL may be smaller than a thickness of the first electrode AND located on the side surfaces of the connection electrode ANC, the side surfaces of the reflective electrode RL, and the side surfaces of the optical auxiliary layer OAL. For example, the thickness of the first electrode AND located on the upper surface of the optical auxiliary layer OAL may be approximately 50 Å or less, and thus light transmittance of the first electrode AND located on the upper surface of the optical auxiliary layer OAL may be increased. In addition, the thickness of the first electrode AND located on the side surfaces of the connection electrode ANC, the side surfaces of the reflective electrode RL and the side surfaces of the optical auxiliary layer OAL may range approximately from 100 Å to 200 Å, and thus it is possible to prevent contact resistance from increasing when the first electrode AND is in contact only with the side surfaces of the connection electrode ANC and the side surfaces of the reflective electrode RL.

The pixel-defining layer PDL may be located partially on the first electrode AND of each of the light-emitting elements LE. The pixel-defining layer PDL may cover an edge of the first electrode AND of each of the light-emitting elements LE. The pixel-defining layer PDL may define the first emission areas EA1, the second emission areas EA2 and the third emission areas EA3.

The first emission area EA1 may be defined as an area in the first sub-pixel SP1 where the first electrode AND, the emission stack IL and the second electrode CAT are sequentially stacked on one another to emit light. The second emission area EA2 may be defined as an area in the second sub-pixel SP2 where the first electrode AND, the emission stack IL and the second electrode CAT are sequentially stacked on one another to emit light. The third emission area EA3 may be defined as an area in the third sub-pixel SP3 where the first electrode AND, the emission stack IL and the second electrode CAT are sequentially stacked on one another to emit light.

The pixel-defining layer PDL may include first to third pixel-defining layers PDL1, PDL2, and PDL3.

The first pixel-defining layer PDL1 may be disposed on the first electrode AND of each of the light-emitting elements LE. Specifically, the first pixel-defining layer PDL1 may cover a part of the first electrode AND located only the upper surface of the optical auxiliary layer OAL. In addition, the first pixel-defining layer PDL1 may cover the first electrode AND which is disposed on the side surfaces of the connection electrode ANC, the side surfaces of the reflective electrode RL and the side surfaces of the optical auxiliary layer OAL. In addition, the first pixel-defining layer PDL1 may cover the first electrode AND that is located on a part of the ninth insulating layer INS9 in the first area AA1. The first pixel-defining layer PDL1 may be located on the second area AA2 of the ninth insulating layer INS9.

The planarization film PNS may provide a flat surface over the ninth insulating layer INS9, the connection electrode ANC, the first step layer STPL1, the second step layer STPL2, the reflective electrode RL and the optical auxiliary layer OAL. The planarization film PNS may be disposed between the connection electrodes ANC adjacent to each other in the first direction DR1 or the second direction DR2. The planarization film PNS may be located between the reflective electrodes RL adjacent to each other in the first direction DR1 or the second direction DR2. The planarization film PNS may be located between the optical auxiliary layer OAL adjacent to each other in the first direction DR1 or the second direction DR2. The planarization film PNS may be located on the first pixel-defining layer PDL1 located on the second area AA2 of the ninth insulating layer INS9.

The second pixel-defining layer PDL2 may be located on the first pixel-defining layer PDL1 and the planarization film PNS, and the third pixel-defining layer PDL3 may be located on the second pixel-defining layer PDL2. The first pixel-defining layer PDL1 and the third pixel-defining layer PDL3 may include a silicon nitride (SiNx)-based inorganic film, while the second pixel-defining layer PDL2 and the planarization film PNS may include a silicon oxide (SiOx)-based inorganic film. When the first pixel-defining layer PDL1 includes a different material from the planarization film PNS, the first pixel-defining layer PDL1 may work as a stopper in a process of chemically and mechanically polishing the planarization film PNS.

A thickness of the first pixel-defining layer PDL1, a thickness of the second pixel-defining layer PDL2 and a thickness of the third pixel-defining layer PDL3 may be, but is not limited to, approximately 500 Å.

When the first pixel-defining layer PDL1, the second pixel-defining layer PDL2 and the third pixel-defining layer PDL3 are formed as a single pixel-defining layer, a height of the single pixel-defining layer increases, and thus the second electrode CAT may be broken due to step coverage. Herein, a step coverage refers to a ratio of a thin film applied on an inclined portion to a thin film applied on a flat portion. The lower the step coverage is, the more likely it is that the thin film would break at the inclined portion.

In order to prevent a first inorganic encapsulation layer TFE1, included in the encapsulation layer TFE, from breaking due to step coverage, the first pixel-defining layer PDL1, the second pixel-defining layer PDL2 and the third pixel-defining layer PDL3 may have a cross-sectional structure in a form of stairs. For example, a width of the first pixel-defining layer PDL1 may be greater than a width of the second pixel-defining layer PDL2 and a width of the third pixel-defining layer PDL3, the width of the second pixel-defining layer PDL2 may be greater than the width of the third pixel-defining layer PDL3. The width of the first pixel-defining layer PDL1 refers to a horizontal length of the first pixel-defining layer PDL1 defined by the first direction DR1 or the second direction DR2.

Each of the plurality of trenches TRC may penetrate the first pixel-defining layer PDL1, the planarization film PNS, the second pixel-defining layer PDL2, and the third pixel-defining layer PDL3. In addition, the ninth insulating layer INS9 may be partially dug in each of plurality of trenches TRC.

At least one trench TRC may be formed between adjacent ones of the emission areas EA1, EA2, and EA3. Although two trenches TRC are formed between adjacent ones of the emission areas EA1, EA2, and EA3 in the example shown in FIGS. 7 and 8, the embodiments of the present disclosure are not limited thereto.

The emission stack IL may include a plurality of stack layers IL1, IL2, and IL3. Although the emission stack IL has a three-tandem structure including the first stack layer IL1, the second stack layer IL2, and a third stack layer IL3 in the example shown in FIGS. 7 and 8, the embodiments of the present disclosure are not limited thereto. For example, the emission stack IL may have a two-tandem structure including two stack layers.

In the three-tandem structure, the emission stack IL may have a tandem structure including the plurality of stack layers IL1, IL2, and IL3 emitting different lights. For example, the emission stack IL may include the first stack layer IL1 that outputs the first light, the second stack layer IL2 that outputs the third light, and the third stack layer IL3 that outputs the second light. The first stack layer IL1, the second stack layer IL2, and the third stack layer IL3 may be sequentially stacked on one another.

The first stack layer IL1 may have a structure in which a first hole transport layer, a first organic light-emitting layer, and a first electron transport layer are sequentially stacked on one another. The second stack layer IL2 may have a structure in which a second hole transport layer, a second organic light-emitting layer, and a second electron transport layer are sequentially stacked on one another. The third stack layer IL3 may have a structure in which a third hole transport layer, a third organic light-emitting layer, and a third electron transport layer are sequentially stacked on one another.

The first organic light-emitting layer, the second organic light-emitting layer, and the third organic emissive layer may provide lights in different wavelength ranges. For example, among the first to third organic light-emitting layers, an organic light-emitting layer may provide the first light, another organic light-emitting layer may provide the second light, and the other organic light-emitting layer may provide the third light.

A first charge generation layer may be arranged between the first stack layer IL1 and the second stack layer IL2 to supply charges to the second stack layer IL2 and electrons to the first stack layer IL1. The first charge generation layer may include an n-type charge generation layer that supplies electrons to the first stack layer IL1, and a p-type charge generation layer that supplies holes to the second stack layer IL2. The n-type charge generation layer may include a dopant of a metallic material.

A second charge generation layer may be located between the second stack layer IL2 and the third stack layer IL3 to supply charges to the third stack layer IL3 and electrons to the second stack layer IL2. The second charge generation layer may include an n-type charge generation layer that supplies electrons to the second stack layer IL2, and a p-type charge generation layer that supplies holes to the third stack layer IL3.

The first stack layer IL1 may be located on the first electrodes AND and the pixel-defining layer PDL. A residual film RIL including the same material as the first stack layer IL1 may be placed on a bottom surface of each of the trenches TRC. Due to the trenches TRC, the first stack layer IL1 may be disconnected between the adjacent sub-pixels SP1, SP2, and SP3. The second stack layer IL2 may be located on the first stack layer IL1. Due to the trenches TRC, the second stack layer IL2 may be disconnected between the adjacent sub-pixels SP1, SP2, and SP3. In each of the trenches TRC, a void or an empty space may be located between the residual film RIL and the second stack layer IL2. The third stack layer IL3 may be disposed on the second stack layer IL2. The third stack layer IL3 may not be disconnected by the trenches TRC and may cover the second stack layer IL2 in each of the trenches TRC.

Therefore, in the three-tandem structure, each of the plurality of trenches TRC may be provided to disconnect the first charge generation layer and the second charge generation layer of the display element layer EML between neighboring sub-pixels SP1, SP2, and SP3 in order to prevent electric current from flowing through the first charge generation layer and the second charge generation layer. In addition, in the two-tandem structure, each of the plurality of trenches TRC may be provided to disconnect a charge generation layer between a lower stack layer and an upper stack layer in order to prevent electric current from flowing through the charge generation layer.

In order to stably disconnect the first charge generation layer and the second charge generation layer of the display element layer EML between the adjacent ones of the emission areas EA1, EA2, and EA3, a height of each of the plurality of trenches TRC may be greater than a height of the pixel-defining layer PDL and a height of the planarization film PNS. The height of each of the plurality of trenches TRC refers to a length measured in the third direction DR3. The height of the pixel-defining layer PDL refer to a length of the pixel-defining layer PDL in the third direction DR3. The height of the planarization film PNS refers to a length of the planarization film PNS in the third direction DR3.

In order to disconnect the first charge generation layer and the second charge generation layer of the display element layer EML, there may be other ways than the trenches TRC between the adjacent ones of the emission areas EA1, EA2, and EA3. For example, instead of the trenches TRC, partition walls in a form of an inverse taper may be arranged on the pixel-defining layer PDL.

The second electrode CAT may be located on the emission stack IL. The second electrode CAT may be located on the third stack layer IL3 in each of a plurality of trenches TRC. The second electrode CAT may be formed as a semi-transmissive conductive material such as magnesium (Mg), silver (Ag), or an alloy of magnesium (Mg) and silver (Ag). In this instance, light extraction efficiency may be increased by using microcavities in each of the first to third sub-pixels SP1, SP2, and SP3.

The encapsulation layer TFE may be located on the display element layer EML. The encapsulation layer TFE may include one or more inorganic films TFE1 and TFE2 to prevent permeation of oxygen or moisture into the display element layer EML. For example, the encapsulation layer TFEL may include the first inorganic encapsulation layer TFE1 and a second inorganic encapsulation layer TFE2.

The first inorganic encapsulation layer TFE1 may be located on the second electrode CAT. The first inorganic encapsulation layer TFE1 may include multiple films in which one or more inorganic films of silicon nitride (SiNx), silicon oxynitride (SiON) and a silicon oxide (SiOx) are alternately stacked on one another. The first inorganic encapsulation layer TFE1 may be formed via a chemical vapor deposition (CVD) process.

The second inorganic encapsulation layer TFE2 may be located on the first inorganic encapsulation layer TFE1. The second inorganic encapsulation layer TFE2 may be formed of titanium oxide (TiOx) or aluminum oxide layer (AlOx), but the embodiments of the present disclosure are not limited thereto. The second inorganic encapsulation layer TFE2 may be formed via an atomic layer deposition (ALD) process. A thickness of the second inorganic encapsulation layer TFE2 may be smaller than a thickness of the first inorganic encapsulation layer TFE1.

An organic layer APL may increase interfacial adhesion between the encapsulation layer TFE and the optical layer OPL. The organic layer APL may be an acryl resin, an epoxy resin, a phenolic resin, a polyamide resin or a polyimide resin.

The optical layer OPL may include a plurality of color filters CF1, CF2, and CF3, a plurality of lenses LNS, and a filling layer FIL. The plurality of color filters CF1, CF2, and CF3 may include first to third color filters CF1, CF2, and CF3. The first to third color filters CF1, CF2, and CF3 may be arranged on the adhesive layer ADL.

The first color filter CF1 may be in line with the first emission area EA1 of the first sub-pixel SP1. The first color filter CF1 may transmit the first light, e.g., light in the red wavelength range. Therefore, the first color filter CF1 may transmit the first light among the lights emitted from the emission stack IL of the first emission area EA1.

The second color filter CF2 may be in line with the second emission area EA2 of the second sub-pixel SP2. The second color filter CF2 may transmit the second light, e.g., light in the green wavelength range. Therefore, the second color filter CF2 may transmit the second light among the lights emitted from the emission stack IL of the second emission area EA2.

The third color filter CF3 may be in line with the third emission area EA3 of the third sub-pixel SP3. The third color filter CF3 may transmit the third light, e.g., light in the blue wavelength range. Therefore, the third color filter CF3 may transmit the third light among the lights emitted from the emission stack IL of the third emission area EA3.

The lenses LNS may be arranged on the first color filter CF1, the second color filter CF2 and the third color filter CF3, respectively. Each of the lenses LNS may be a structure for increasing a ratio of light directed to a front side of the display device 10. Each of the lenses LNS may have a cross-sectional shape that is convex upward. It should be understood, however, that the embodiments of the present disclosure are not limited thereto.

The filling layer FIL may be located on the plurality of lenses LNS. The filling layer FIL may have a predetermined refractive index such that light travels in the third direction DR3 at an interface between the plurality of lenses LNS and the filling layer FIL. In addition, the filling layer FIL may be a planarization layer. The filling layer FIL may be an organic film such as an acryl resin, an epoxy resin, a phenolic resin, a polyamide resin, and a polyimide resin.

The cover layer CVL may be located on the filling layer FIL. The cover layer CVL may be a glass substrate or a polymer resin such as a resin. If the cover layer CVL is a glass substrate, the cover layer CVL may be attached to the filling layer FIL. In this instance, the filling layer FIL may adhere to the cover layer CVL. If the cover layer CVL is a glass substrate, the cover layer CVL may work as an encapsulation substrate. If the cover layer CVL is a polymer resin such as a resin, the cover layer CVL may be applied directly on the filling layer FIL.

The polarizing plate POL may be located on a surface of the cover layer CVL. The polarizing plate POL may prevent deterioration of visibility due to reflection of external light. The polarizing plate POL may include a linear polarizing plate and a phase retardation film. For example, the phase retardation film may be a λ/4 plate (quarter-wave plate), but the embodiments of the present disclosure are not limited thereto. If visibility is sufficiently improved by the first to third color filters CF1, CF2, and CF3 regardless of reflection of external light, the polarizing plate POL may be eliminated.

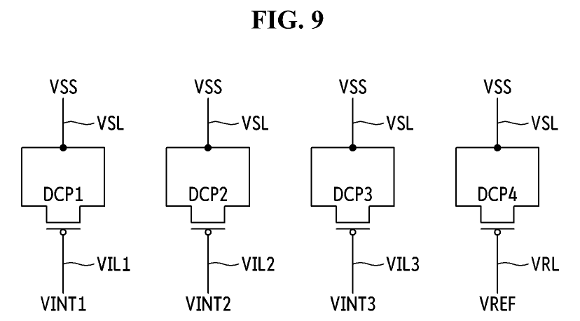

FIG. 9 is a diagram for explaining a decoupling capacitor located in the decoupling circuit.

As illustrated in FIG. 9, the decoupling circuit DCC may include a first decoupling capacitor DCP1, a second decoupling capacitor DCP2, a third decoupling capacitor DCP3, and a fourth decoupling capacitor DCP4. For example, at least one of the above-described first to third decoupling circuits DCC1 to DCC3 may include the first decoupling capacitor DCP1, the second decoupling capacitor DCP2, the third decoupling capacitor DCP3, and the fourth decoupling capacitor DCP4.

The first decoupling capacitor DCP1 may be formed of a transistor (e.g., p-type transistor) including a gate electrode connected to a third-first driving voltage line VINT1, a source electrode connected to the first driving voltage line VSL, and a drain electrode connected to the first driving voltage line VSL. For example, the first decoupling capacitor DCP1 may include any one of a metal-oxide-semiconductor (MOS) capacitor, a metal-oxide-metal (MOM) capacitor, and a metal-insulator-metal (MIM) capacitor.

The second decoupling capacitor DCP2 may be formed of a transistor (e.g., p-type transistor) including a gate electrode connected to a third-second driving voltage line VINT2, a source electrode connected to the first driving voltage line VSL, and a drain electrode connected to the first driving voltage line VSL. For example, the second decoupling capacitor DCP2 may include any one of a metal-oxide-semiconductor (MOS) capacitor, a metal-oxide-metal (MOM) capacitor, and a metal-insulator-metal (MIM) capacitor.

The third decoupling capacitor DCP3 may be formed of a transistor (e.g., p-type transistor) including a gate electrode connected to a third-third driving voltage line VINT3, a source electrode connected to the first driving voltage line VSL, and a drain electrode connected to the first driving voltage line VSL. For example, the third decoupling capacitor DCP3 may include any one of a metal-oxide-semiconductor (MOS) capacitor, a metal-oxide-metal (MOM) capacitor, and a metal-insulator-metal (MIM) capacitor.

The fourth decoupling capacitor DCP4 may be formed of a transistor (e.g., p-type transistor) including a gate electrode connected to the fourth driving voltage line VRL, a source electrode connected to the first driving voltage line VSL, and a drain electrode connected to the first driving voltage line VSL. For example, the fourth decoupling capacitor DCP4 may include any one of a metal-oxide-semiconductor (MOS) capacitor, a metal-oxide-metal (MOM) capacitor, and a metal-insulator-metal (MIM) capacitor.

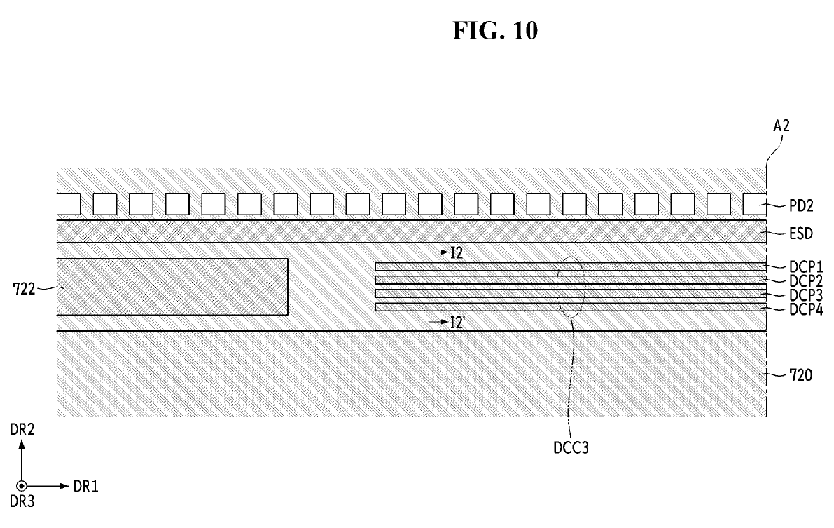

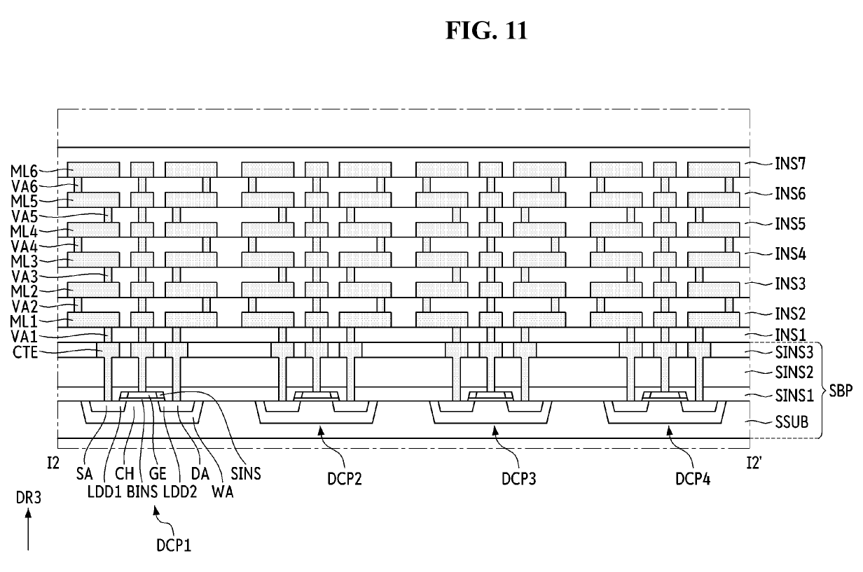

FIG. 10 is a cross-sectional view showing area A2 of FIG. 4 in detail, and FIG. 11 is a cross-sectional view showing an example of the display panel taken along line I2 – I2’ of FIG. 10.

As illustrated in FIG. 10, the third decoupling circuit DCC3 may include a first decoupling capacitor DCP1, a second decoupling capacitor DCP2, a third decoupling capacitor DCP3, and a fourth decoupling capacitor DCP4.

The first decoupling capacitor DCP1, the second decoupling capacitor DCP2, the third decoupling capacitor DCP3, and the fourth decoupling capacitor DCP4 may be sequentially placed along a reverse direction of the second direction DR2 between the second distribution circuit 720 and the second pad PD2 (or the second pad area PDA2).

In addition, as illustrated in FIG. 10, an anti-static circuit ESD for preventing static electricity may be further located between the second pad PD2 and the decoder 722. This anti-static circuit ESD may be also located between the second pad PD2 and the third decoupling circuit DCC3.

As illustrated in FIG. 11, each of the first driving voltage line VSL, the third driving voltage line VIL, the third-first driving voltage line VINT1, the third-second driving voltage line VINT2, the third-third driving voltage line VINT3, and the fourth driving voltage line VRL may be formed of the sixth conductive layer ML6.

As illustrated in FIG. 11, the first decoupling capacitor DCP1 may include a gate electrode GE, a source region SA, and a drain region DA. The source region SA of the first decoupling capacitor DCP1 may correspond to the source electrode of the first decoupling capacitor DCP1, and the drain region DA of the first decoupling capacitor DCP1 may correspond to the drain electrode of the first decoupling capacitor DCP1.

The gate electrode GE of the first decoupling capacitor DCP1 may be connected to the third-first driving voltage line VINT1 formed of the sixth conductive layer ML6 through the contact terminal CTE, the first to fifth conductive layers ML1 to ML5, and the first to sixth via electrodes VA1 to VA6. The source region SA (or the source electrode) of the first decoupling capacitor DCP1 may be connected to the first driving voltage line VSL formed of the sixth conductive layer ML6 through the contact terminal CTE, the first to fifth conductive layers ML1 to ML5, and the first to sixth via electrodes VA1 to VA6. The drain region DA (or the drain electrode) of the first decoupling capacitor DCP1 may be connected to the first driving voltage line VSL formed of the sixth conductive layer ML6 through the contact terminal CTE, the first to fifth conductive layers ML1 to ML5, and the first to sixth via electrodes VA1 to VA6.

The second decoupling capacitor DCP2 may include a gate electrode, a source region, and a drain region. The source region of the second decoupling capacitor DCP2 may correspond to the source electrode of the second decoupling capacitor DCP2, and the drain region of the second decoupling capacitor DCP2 may correspond to the drain electrode of the second decoupling capacitor DCP2.

The gate electrode of the second decoupling capacitor DCP2 may be connected to the third-second driving voltage line VINT2 formed of the sixth conductive layer ML6 through the contact terminal CTE, the first to fifth conductive layers ML1 to ML5, and the first to sixth via electrodes VA1 to VA6. The source region (or the source electrode) of the second decoupling capacitor DCP2 may be connected to the first driving voltage line VSL formed of the sixth conductive layer ML6 through the contact terminal CTE, the first to fifth conductive layers ML1 to ML5, and the first to sixth via electrodes VA1 to VA6. The drain region (or the drain electrode) of the second decoupling capacitor DCP2 may be connected to the first driving voltage line VSL formed of the sixth conductive layer ML6 through the contact terminal CTE, the first to fifth conductive layers ML1 to ML5, and the first to sixth via electrodes VA1 to VA6.

The third decoupling capacitor DCP3 may include a gate electrode, a source region, and a drain region. The source region of the third decoupling capacitor DCP3 may correspond to the source electrode of the third decoupling capacitor DCP3, and the drain region of the third decoupling capacitor DCP3 may correspond to the drain electrode of the third decoupling capacitor DCP3.

The gate electrode of the third decoupling capacitor DCP3 may be connected to the third-third driving voltage line VINT3 formed of the sixth conductive layer ML6 through the contact terminal CTE, the first to fifth conductive layers ML1 to ML5, and the first to sixth via electrodes VA1 to VA6. The source region (or the source electrode) of the third decoupling capacitor DCP3 may be connected to the first driving voltage line VSL formed of the sixth conductive layer ML6 through the contact terminal CTE, the first to fifth conductive layers ML1 to ML5, and the first to sixth via electrodes VA1 to VA6. The drain region (or the drain electrode) of the third decoupling capacitor DCP3 may be connected to the first driving voltage line VSL formed of the sixth conductive layer ML6 through the contact terminal CTE, the first to fifth conductive layers ML1 to ML5, and the first to sixth via electrodes VA1 to VA6.

The fourth decoupling capacitor DCP4 may include a gate electrode, a source region, and a drain region. The source region of the fourth decoupling capacitor DCP4 may correspond to the source electrode of the fourth decoupling capacitor DCP4, and the drain region of the fourth decoupling capacitor DCP4 may correspond to the drain electrode of the fourth decoupling capacitor DCP4.

The gate electrode of the fourth decoupling capacitor DCP4 may be connected to the fourth driving voltage line VRL formed of the sixth conductive layer ML6 through the contact terminal CTE, the first to fifth conductive layers ML1 to ML5, and the first to sixth via electrodes VA1 to VA6. The source region (or the source electrode) of the fourth decoupling capacitor DCP4 may be connected to the first driving voltage line VSL formed of the sixth conductive layer ML6 through the contact terminal CTE, the first to fifth conductive layers ML1 to ML5, and the first to sixth via electrodes VA1 to VA6. The drain region (or the drain electrode) of the fourth decoupling capacitor DCP4 may be connected to the first driving voltage line VSL formed of the sixth conductive layer ML6 through the contact terminal CTE, the first to fifth conductive layers ML1 to ML5, and the first to sixth via electrodes VA1 to VA6.

The first to fourth decoupling capacitors DCP1 to DCP4 of the third decoupling circuit DCC3 and the first to fourth decoupling capacitors DCP1 to DCP4 of the second decoupling circuit DCC2 may be connected to each other through a bus line. For example, the source regions (or the drain regions) of the first to fourth decoupling capacitors DCP1 to DCP4 may be commonly connected to one bus line. Here, the bus line, for example, may be formed of the third conductive layer ML3 and the fourth conductive layer ML4.

The display device 10 according to an embodiment may be applied to a variety of electronic devices. An electronic device according to an embodiment may include the display device 10 described above, and may further include a module or a device having additional features in addition to the display device 10.

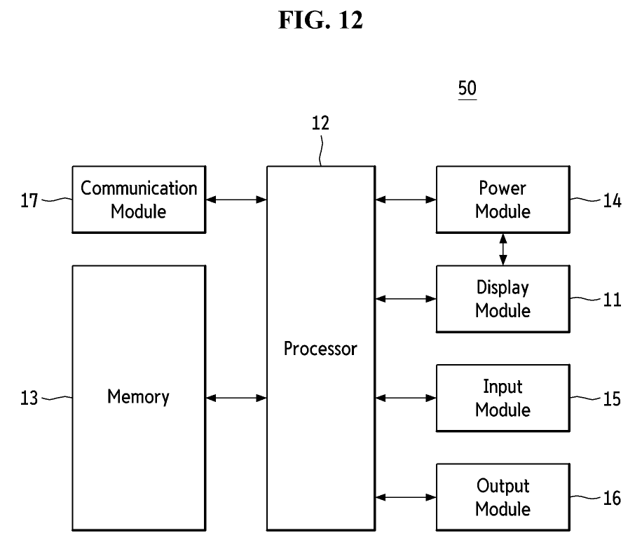

FIG. 12 is a block diagram of an electronic device according to an embodiment of the present disclosure.

Referring to FIG. 12, an electronic device 50 according to an embodiment of the present disclosure may include a display module 11, a processor 12, a memory 13, and a power module 14. The electronic device 50 may further include an input module 15, a non-image output module 16, and/or a communication module 17.

The electronic device 50 may output various information in a form of an image through the display module 11. When the processor 12 executes an application stored in the memory 13, image information provided by the application may be provided to a user through the display module 11. The power module 14 may include a power supply module such as a power adapter and a battery device, and a power conversion module that converts power supplied by the power supply module to generate power for an operation of the electronic device 50. The input module 15 may provide input information to the processor 12 and/or the display module 11. The non-image output module 16 may receive information other than an image from the processor 12, such as sound, haptic and light information, and provide the information to the user. The communication module 17 may transmit and receive information between the electronic device 50 and an external device, and may include a receiving unit and a transmitting unit.

At least one of the elements of the electronic device 50 described above may be included in a display device according to embodiments described above. In addition, some of individual modules functioning as a single module may be included in the display device while some other modules may be provided separately from the display device. For example, the display device may include the display module 11, and the processor 12, the memory 13 and the power module 14 may be implemented as other devices inside the electronic device 50 instead of the display device.

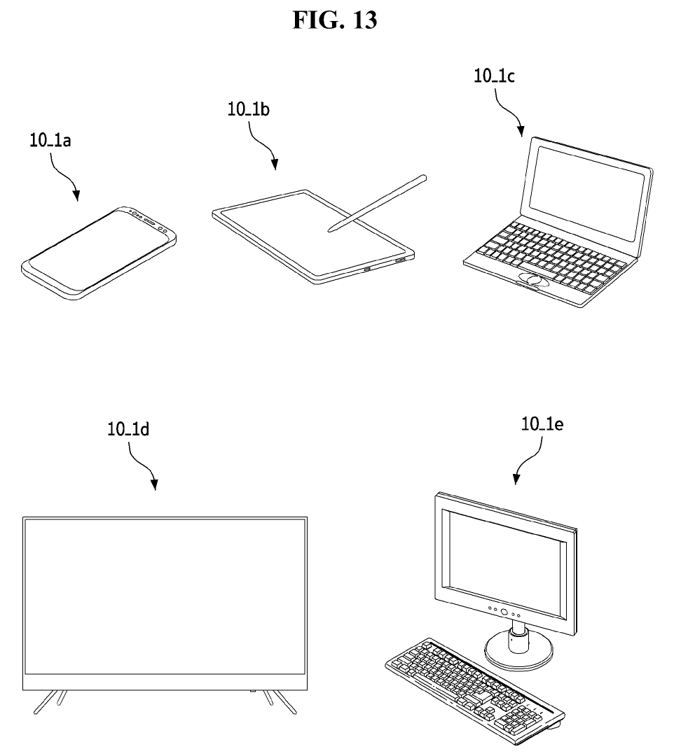

FIGS. 13, 14 and 15 are views showing electronic devices according to a variety of embodiments of the present disclosure. FIGS. 13 to 15 show examples of a variety of electronic devices employing the display devices 10 according to embodiments.

FIG. 13 shows a smartphone 10_1a, a tablet PC 10_1b, a laptop computer 10_1c, a TV 10_1d, and a desktop monitor 10_1e as examples of the electronic devices.

The smartphone 10_1a may include an input module such as a touch sensor and a communication module in addition to the display module 11 shown in FIG. 12. The smartphone 10_1a may process information received through the communication module or other input modules and display the information through the display module of the display device.

The tablet PCs 10_1b, the laptop computer 10_1c, the TV 10_1d and the desktop monitor 10_1e may include display modules and input modules similar to the smartphone 10_1a, and may further include communication modules as desired.

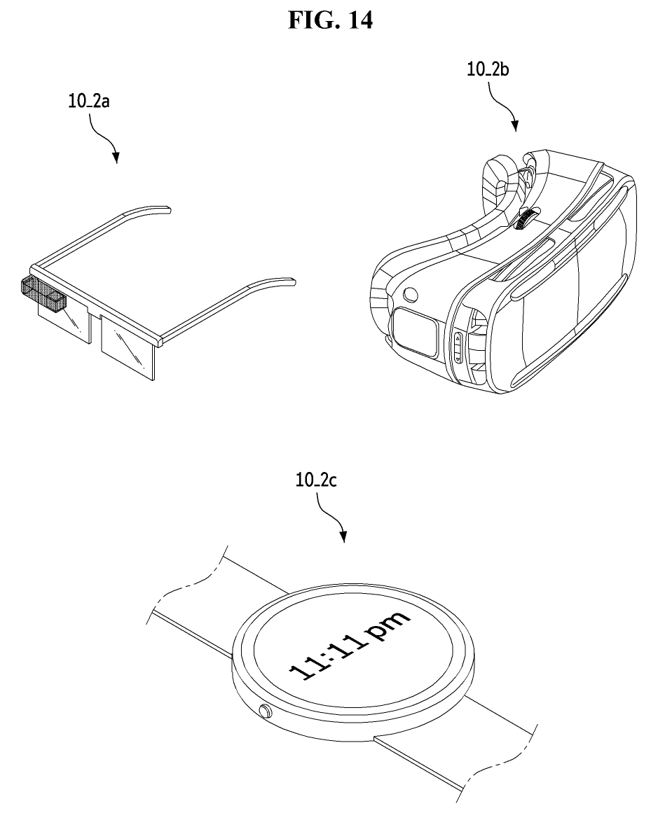

FIG. 14 shows examples of a wearable electronic device employing an electronic device including a display module. The wearable electronic devices may be smart glasses 10_2a, a head-mounted display 10_2b, a smart watch 10_2c, etc.

The smart glasses 10_2a and the head-mounted display 10_2b may include a display module that outputs a display image, and a reflector that reflects the output display image and provides the reflected image to the user’s eyes, thereby providing the user with an image of virtual reality or augmented reality on a screen.

The smart watch 10_2c may include a biometric sensor as an input device, and may provide the user with biometric information recognized by the biometric sensor through the display module.

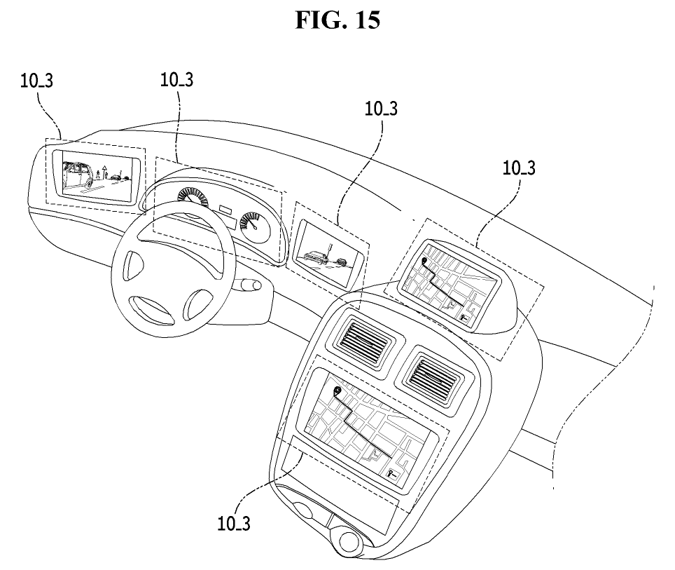

FIG. 15 shows an example of an electronic device including a display module applied to a vehicle. For example, an electronic device 10_3 may be applied to an instrument cluster, a center fascia, etc., of a vehicle, or may be applied to a center information display (CID) located at a dashboard of a vehicle, or may be used as a room mirror display instead of a side mirror of the vehicle.

According to an embodiment of the present disclosure, a noise of a driving voltage and a voltage drop may be reduced.

For example, according to an embodiment, as a plurality of decoupling circuits are located in the non-display area, a noise of a driving voltage and a voltage drop may be minimized. In particular, since a second decoupling circuit and a third decoupling circuit are located in an area with relatively less wiring compared to a first decoupling circuit, each of the second decoupling circuit and the third decoupling circuit may have a greater size than the first decoupling circuit. Accordingly, a noise of the driving circuit and a voltage drop may be reduced.

The effects of the present disclosure are not limited to the above-described effects and other effects which are not described herein will become apparent to those skilled in the art from the following description.

At least one of the components, elements, modules or units (collectively “components” in this paragraph) represented by a block in the drawings, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A display device comprising:
a display panel comprising a display area and a non-display area;
a data driver, which is in the non-display area and is adjacent to a first edge of the display area; and
a first decoupling circuit, which is in the non-display area, is adjacent to a second edge of the display area, and is connected to a sub-pixel of the display area through a driving voltage line, the second edge being opposite to the first edge.

2. The display device of claim 1, further comprising a second decoupling circuit, which is in the non-display area and is adjacent to the second edge of the display area and the first decoupling circuit.

3. The display device of claim 2, further comprising a decoder between the first decoupling circuit and the second decoupling circuit.

4. The display device of claim 1, further comprising a first distribution circuit between the first decoupling circuit and the second edge of the display area.

5. The display device of claim 1, further comprising a first pad adjacent to the first decoupling circuit.

6. The display device of claim 5, further comprising an anti-static circuit between the first pad and the first decoupling circuit.

7. The display device of claim 1, wherein the first decoupling circuit comprises a plurality of decoupling capacitors.

8. The display device of claim 7, wherein the driving voltage line comprises a plurality of driving voltage lines, and
wherein the plurality of decoupling capacitors are connected to the plurality of driving voltage lines, respectively.

9. The display device of claim 7, wherein the driving voltage line comprises a first driving voltage line, a second driving voltage line, a third driving voltage line, and a fourth driving voltage line that provide different voltages, and
wherein the plurality of decoupling capacitors comprise:
a first decoupling capacitor connected to the sub-pixel through the first driving voltage line;
a second decoupling capacitor connected to the sub-pixel through the second driving voltage line;
a third decoupling capacitor connected to the sub-pixel through the third driving voltage line; and
a fourth decoupling capacitor connected to the sub-pixel through the fourth driving voltage line.

10. The display device of claim 7, wherein at least one of the plurality of decoupling capacitors comprises any one of metal-oxide-semiconductor (MOS) capacitor, a metal-oxide-metal (MOM) capacitor, and a metal-insulator-metal (MIM) capacitor.

11. The display device of claim 1, further comprising a third decoupling circuit between the first edge of the display area and the data driver in the non-display area.

12. The display device of claim 11, wherein a size of the first decoupling circuit is larger than a size of the third decoupling circuit.

13. The display device of claim 11, further comprising a second distribution circuit between the third decoupling circuit and the data driver.

14. The display device of claim 1, further comprising a second pad adjacent to the data driver.

15. The display device of claim 1, further comprising a scan driver in the non-display area.

16. The display device of claim 1, further comprising an emission driver in the non-display area.

17. An electronic device comprising a display device configured to provide a display screen,
wherein the display device comprises:
a display panel comprising a display area and a non-display area;
a data driver, which is in the non-display area and is adjacent to a first edge of the display area; and
a first decoupling circuit, which is in the non-display area, is adjacent to a second edge of the display area, and is connected to a sub-pixel of the display area through a driving voltage line, the second edge being opposite to the first edge.

18. The electronic device of claim 17, further comprising a second decoupling circuit, which is in the non-display area and is adjacent to the second edge of the display area and the first decoupling circuit.

19. The electronic device of claim 18, further comprising a decoder between the first decoupling circuit and the second decoupling circuit.

20. The electronic device of claim 17, wherein the electronic device comprises a smartphone, a tablet personal computer (PC), a laptop computer, a television (TV), a desktop monitor, smart glasses, a smart watch, a head-mounted display, and a display for vehicles.
